(19) United States
(12) Patent Application Publication
(10) Pub. No.: US 2019/0122286 A1
(43) Pub. Date: Apr. 25, 2019

(54) Systems and Methods for Providing User-Activity-Based Rewards and Customized Recommendations

(71) Applicant: MY Mavens LLC, New York, NY (US)

(72) Inventor: Garrett Lang, Mahwah, NJ (US)

(73) Assignee: MY Mavens LLC, New York, NY (US)

(21) Appl. No.: 16/168,767

(22) Filed: Oct. 23, 2018

Related U.S. Application Data
(60) Provisional application No. 62/576,198, filed on Oct. 24, 2017.

(51) Int. Cl. G06Q 30/06; G06Q 30/02; G06Q 10/02

(52) U.S. Cl. CPC G06Q 30/0631; G06Q 30/0217; G06Q 10/02; G06Q 30/0226; G06Q 30/0261; G06Q 30/0224

(57) ABSTRACT

Various embodiments are disclosed herein for providing customized product recommendations to vendors based on user activity information, such as product purchases and product reviews. The embodiments may be further adapted to provide rewards to users based on such activity information. Moreover, the embodiments may further track and update vendor and user locations to allow for targeted searches to be performed and/or to facilitate interactions among any number of vendors and users.

### CROSS-REFERENCE TO RELATED APPLICATIONS

The present application claims benefit of U.S. Provisional Patent Application 62/576,198, titled “Systems and Methods for Providing User-Activity-Based Rewards and Customized Recommendations,” filed Oct. 24, 2017, which is incorporated by reference herein in its entirety.

### BACKGROUND

This specification relates generally to systems and methods for providing customized recommendations to vendors and/or rewards to users, based on user activity.

The collection and displaying of user activity information, such as user product reviews and orders, has become ubiquitous among electronic commerce (“ecommerce”) businesses. Such information may allow an ecommerce business to understand their users' preferences and may facilitate product orders by ecommerce customers. For example, an estimated 88% of US consumers trust online reviews as much as a personal recommendation and 82% of US adults report that they read online user ratings or reviews before purchasing items.

Despite the importance of user reviews, ecommerce businesses do not properly incentivize users to leave reviews and do not offer functionality that assists or guides users to provide useful information. Formfilling—the method by which most ecommerce businesses currently allow users to leave reviews—is time-consuming and tedious, and, therefore, discourages users from providing reviews. Even when customers agree to review ecommerce products and/or services, such reviews are usually broad, freeform textual responses, with “holistic” ratings that conflate a variety of factors (e.g., quality of service at a restaurant, taste of one particular dish at the restaurant, and presentation of the dish at the restaurant). Unfortunately, this makes review-based comparisons of individual products and/or vendors difficult, and often prevents ecommerce businesses from determining actionable insights from reviews.

Accordingly, there is a need for systems and methods that are adapted to incentive users of ecommerce platforms to review products and services offered by vendors (e.g., by providing one or more rewards based on user activity or by providing notifications and/or reminders regarding such rewards). It would be beneficial if such systems and methods allowed users to provide structured reviews that may be filtered, sorted, searched and/or otherwise utilized to compare various vendors' products and services.

It would be further beneficial if such systems and methods allowed for user reviews and other user activity information to be utilized to generate and transmit customized product and service recommendations to vendors. It would also be beneficial if the systems and methods were adapted to track location information relating to various entities (e.g., vendors, service providers, etc.) and to facilitate communication among entities across any number of industries.

### SUMMARY

In accordance with the foregoing objectives and others, exemplary systems and methods are disclosed herein for providing customized product recommendations to vendors (e.g., by a server or other means) based on user activity information, such as users' product purchases and product reviews. The disclosed systems and methods may allow or guide users to search for and/or provide product reviews including ratings of individual product components and/or other properties of products, and may employ such information to determine the recommendations. The disclosed systems and methods may further allow for ease of communication and contact between entities, whether within the same industry or across industries. The disclosed systems and methods may allow an entity's location to automatically be tracked.

Additionally or alternatively, exemplary systems and methods for providing user-activity-based rewards are disclosed herein. The providing of rewards may be conditioned on any number of users' activities, such as but not limited to purchasing products and/or leaving product reviews. And such reward conditions may be customized for individual customers, vendors, products and/or product features/add-ons.

In one embodiment, a method for providing customized product recommendations based on user activity information is provided. The method may include receiving a product order from a user. The product order may include user information associated with the user, a product associated with product information, and a first vendor associated with first vendor information. The method may further include receiving (e.g., by a server) a request to determine a recommendation from a requestor. The request may be to determine a recommendation for a second vendor associated with second vendor information. The product recommendation may be determined based on the second vendor information and one or more of the group consisting of: the user information, the product information, and the first vendor information. The product recommendation may be transmitted to the requestor.

In another embodiment, a computer-implemented method for providing user-activity-based rewards is provided. The method may include displaying or transmitting to a user, a plurality of products for sale, where each product may be associated with a vendor. The method may further include receiving a product order from the user, where the product order may include a product selected from the plurality of products. The method may further include providing, to the user, a notification to review the product (e.g., a reminder to rate the product after a meal). The method may further include receiving, from the user, a review associated with the product (e.g., a rating for the product, a comment about the product and/or an answer to a question about the product). The method may also include determining a reward, based on one or more of the group consisting of: the user, the product, the vendor and the review; and providing the reward to the user. Exemplary rewards may include, but are not limited to: a first product order associated with the product that is received from any user, a first review associated with the product that is received from any user, a first product order received from the user, a first review received from the user, a first product order received from the user associated with any product associated with the vendor, a first review received from the user associated with any product associated with the vendor, a first time the user has provided any specific data point about the product, a total number of reviews received from the user is greater than or equal to a predetermined review milestone, a total number of products associated with the vendor and ordered by the user is greater than or equal to a predetermined product milestone, and the review information matches a predetermined criterion.

In another embodiment, a method for automatically tracking vendor location is provided. The method may include receiving a request from a vendor that includes vendor information associated with the vendor, such as a first location. The method may further include associating the request with the first location and storing the first location in a database. The method may also include receiving a second request from the vendor that includes a second location, associating the second request with the second location and storing the second location in the database.

In another embodiment, a method for providing targeted searching capabilities is provided. The method may include storing, in a database, a plurality of reviews. Each of the reviews may be associated with: review information selected from the group consisting of: a unique review ID, a user who provided the review, a vendor to whom the review relates, a product to which the review relates, a total or aggregate rating relating to the product, one or more ratings relating to individual product components, one or more comments and one or more corresponding rewards awarded based on the review. Each of the reviews may also be associated with a review location. The method may further include storing, in the database, a plurality of destinations, each of the destinations associated with a destination location. The method may include receiving, from an input device associated with a user, user preferences information. The user preferences information may include one or more of: a desired user associated with a review, a product associated with a review, a total or aggregate rating associated with a review, one or more ratings related to individual product components associated with a review, and any number of comments associated with a review. The method may also include receiving, from the input device, locating information. The locating information may include: a location of the user, location of the input device, and a location designated by the user. The method may also include receiving, from the input device, a desired radius limitation. The method may include transmitting, to the input device, one or more matching reviews selected from the plurality of reviews stored in the database, upon a determination that: the review location associated with each of the matching reviews is within the desired radius limitation of the locating information and the received user preferences information is comparable to the review information associated with each of the matching reviews. The method may also include receiving, from the input device, a selected review selected from the one or more matching reviews. The method may further include transmitting, to the input device, at least a portion of the review information associated with the selected review. The portion of the review information transmitted to the input device may include at least one of: the unique review ID, the user who provided the review, the vendor to whom the review relates, the product to which the review relates, the total or aggregate rating relating to the product, the one or more ratings relating to individual product components, the one or more comments and the one or more corresponding rewards awarded based on the review.

In another embodiment, a method for allowing vendors to create meetings with other vendors is provided. The method may include storing, in a database, a plurality of vendors. Each of the vendors may be associated with vendor information. The vendor information may include: a name, a phone number, an email address, one or more location(s), a description, one or more images, hours of operation, one or more product(s) offered, one or more reviews and/or ratings, a vendor type or category, target personnel information, and revenue information. Each of the vendors may also be associated with a vendor location. The method may also include storing, in the database, a plurality of destinations. Each of the destinations may be associated with a destination location. The method may also include receiving, from an input device associated with a user, user preferences information. The user preferences information may include one or more of: a name associated with a vendor, a phone number associated with a vendor, an email address associated with a vendor, one or more location(s) associated with a vendor, a description associated with a vendor, one or more images associated with a vendor, hours of operation associated with a vendor, one or more product(s) offered associated with a vendor, one or more reviews and/or ratings associated with a vendor, a vendor type or category, target personnel information associated with a vendor, and revenue information associated with a vendor. The method may also include receiving, from the input device, locating information. The locating information may include: a location of the user, location of the input device, and a location designated by the user. The method may further include receiving, from the input device, a desired radius limitation. The method may also include transmitting, to the input device, one or more matching vendors selected from the plurality of vendors stored in the database, upon a determination that: the vendor location associated with each of the matching vendors is within the desired radius limitation of the locating information and the received user preferences information is comparable to the vendor information associated with each of the matching vendors. The method may also include receiving, from the input device, a selected vendor selected from the one or more matching vendors and a meeting request associated with the selected vendor. The method may include creating a meeting based on the meeting request. The method may also include transmitting, to the input device, a confirmation of the meeting.

In yet another embodiment, a system is provided that includes one or more computers and one or more storage devices storing instructions that when executed by the one or more computers cause the one or more computers to perform operations for providing customized recommendations to vendors based on user activity relating to products associated with other vendors. The operations performed may include receiving a product order from a user, where the product order may include, or otherwise be associated with, user information relating to the user, a product associated with product information, and a first vendor associated with first vendor information. The operations performed may further include receiving a request to determine a recommendation from a requestor, such as a request to determine a recommendation for a second vendor associated with second vendor information. The product recommendation may be determined based on the second vendor information and at least one of the following: the user information, the product information, and the first vendor information; and the product recommendation may be transmitted to the requestor.

In another embodiment, a system is provided that includes one or more computers and one or more storage devices storing instructions that when executed by the one or more computers cause the one or more computers to perform operations for providing user-activity-based rewards. The operations performed may include displaying a plurality of products for sale; receiving a product order from a user, where the product order may include a product selected from the plurality of products and may be associated with a vendor; and/or providing, to the user, a notification to review the product. It may further include receiving, from the user, a review associated with the product, where the review may include one or more of a rating, a comment and an answer to a question. The operations may further include determining a reward based on one or more of the group consisting of: the user, the product, the vendor and the review; and providing the reward to the user.

In another embodiment, a system is provided that includes one or more computers and one or more storage devices storing instructions that when executed by the one or more computers cause the one or more computers to perform operations for automatically tracking vendor location. The operations performed may include receiving a request from a vendor, where the request includes vendor information, such as a first location. The operations performed may further include associating the request with the first location and storing the first location in a database. The operations performed may also include receiving a second request from the vendor that includes additional vendor information, such as a second location; associating the second request with the second location; and storing the second location in the database.

In another embodiment, a system is provided that includes one or more computers and one or more storage devices storing instructions that when executed by the one or more computers cause the one or more computers to perform operations for providing targeted searching capabilities. The operations performed may include storing, in a database, a plurality of reviews. Each of the reviews may be associated with: review information selected from the group consisting of: a unique review ID, a user who provided the review, a vendor to whom the review relates, a product to which the review relates, a total or aggregate rating relating to the product, one or more ratings relating to individual product components, one or more comments and one or more corresponding rewards awarded based on the review. Each of the reviews may also be associated with a review location. The operations performed may further include storing, in the database, a plurality of destinations, each of the destinations associated with a destination location. The operations performed may include receiving, from an input device associated with a user, user preferences information. The user preferences information may include one or more of: a desired user associated with a review, a product associated with a review, a total or aggregate rating associated with a review, one or more ratings related to individual product components associated with a review, and any number of comments associated with a review. The operations performed may also include receiving, from the input device, locating information. The locating information may include: a location of the user, location of the input device, and a location designated by the user. The operations performed may also include receiving, from the input device, a desired radius limitation. The operations performed may include transmitting, to the input device, one or more matching reviews selected from the plurality of reviews stored in the database, upon a determination that: the review location associated with each of the matching reviews is within the desired radius limitation of the locating information and the received user preferences information is comparable to the review information associated with each of the matching reviews. The operations performed may also include receiving, from the input device, a selected review selected from the one or more matching reviews. The operations performed may further include transmitting, to the input device, at least a portion of the review information associated with the selected review. The portion of the review information transmitted to the input device may include at least one of: the unique review ID, the user who provided the review, the vendor to whom the review relates, the product to which the review relates, the total or aggregate rating relating to the product, the one or more ratings relating to individual product components, the one or more comments and the one or more corresponding rewards awarded based on the review.

In another embodiment, a system is provided that includes one or more computers and one or more storage devices storing instructions that when executed by the one or more computers cause the one or more computers to perform operations for allowing vendors to create meetings with other vendors. The operations performed may include storing, in a database, a plurality of vendors. Each of the vendors may be associated with vendor information. The vendor information may include: a name, a phone number, an email address, one or more location(s), a description, one or more images, hours of operation, one or more product(s) offered, one or more reviews and/or ratings, a vendor type or category, target personnel information, and revenue information. Each of the vendors may also be associated with a vendor location. The operations performed may also include storing, in the database, a plurality of destinations. Each of the destinations may be associated with a destination location. The operations performed may also include receiving, from an input device associated with a user, user preferences information. The user preferences information may include one or more of: a name associated with a vendor, a phone number associated with a vendor, an email address associated with a vendor, one or more location(s) associated with a vendor, a description associated with a vendor, one or more images associated with a vendor, hours of operation associated with a vendor, one or more product(s) offered associated with a vendor, one or more reviews and/or ratings associated with a vendor, a vendor type or category, target personnel information associated with a vendor, and revenue information associated with a vendor. The operations performed may also include receiving, from the input device, locating information. The locating information may include: a location of the user, location of the input device, and a location designated by the user. The operations performed may further include receiving, from the input device, a desired radius limitation. The operations performed may also include transmitting, to the input device, one or more matching vendors selected from the plurality of vendors stored in the database, upon a determination that: the vendor location associated with each of the matching vendors is within the desired radius limitation of the locating information and the received user preferences information is comparable to the vendor information associated with each of the matching vendors. The operations performed may also include receiving, from the input device, a selected vendor selected from the one or more matching vendors and a meeting request associated with the selected vendor. The operations performed may include creating a meeting based on the meeting request. The operations performed may also include transmitting, to the input device, a confirmation of the meeting.

### BRIEF DESCRIPTION OF THE DRAWINGS

FIG. 1 shows an exemplary ecommerce system 100 in accordance with one or more embodiments presented herein.

FIG. 2 shows an exemplary computing machine 200 and modules 230 in accordance with one or more embodiments presented herein.

FIG. 3 shows a method 300 for providing user-activity-based rewards to users in accordance with one or more embodiments described herein.

FIG. 4A and 4B show an exemplary order details screen 400 in accordance with one or more embodiments presented herein.

FIG. 5 shows an exemplary product rating screen 500 in accordance with one or more embodiments presented herein.

FIG. 6 shows an exemplary notifications settings screen 600 in accordance with one or more embodiments presented herein.

FIG. 7 shows an exemplary rewards database table 700 storing user-activity-based rewards offered by various vendors in accordance with one or more embodiments presented herein.

FIG. 8 shows an exemplary nearby credits notifications settings screen 800 in accordance with one or more embodiments presented herein.

FIG. 9 shows an exemplary nearby deals notifications settings screen 900 in accordance with one or more embodiments presented herein.

FIG. 10 shows an exemplary reviews database table 1000 storing user reviews of various products associated with vendors in accordance with one or more embodiments presented herein.

FIG. 11 shows an exemplary reviews social search screen 1100 in accordance with one or more embodiments presented herein.

FIG. 12 shows an exemplary search screen 1200 of a user's reviews in accordance with one or more embodiments presented herein.

FIG. 13 shows a method 1300 for determining product recommendations for vendors, based on user activity information in accordance with one or more embodiments presented herein.

FIG. 14 shows an exemplary recommendations user interface 1400 in accordance with one or more embodiments presented herein.

FIGS. 15A and 15B show an exemplary customer relations management decisionmaker settings screen 1500 in accordance with one or more embodiments presented herein.

### DETAILED DESCRIPTION

Various systems and methods are disclosed herein for determining customized recommendations for vendors, wherein such recommendations may be based on customer activities, such as product purchases and product reviews. To that end, the disclosed systems and methods may allow users to purchase products and/or services offered by various vendors via an ecommerce application. The disclosed embodiments may guide users (e.g., customers who have purchased products and/or services from a vendor) to provide detailed reviews in a structured format, including ratings of individual product components and/or other properties of products and services.

The disclosed embodiments may be adapted to determine activity-based rewards and provide the same to users. The providing of rewards may be conditioned on any number of user activities, such as but not limited to listing products for purchase, purchasing products, providing product reviews and/or including particular details in such reviews. Moreover, such reward conditions may be customized for individual customers, vendors and/or products as desired to incentivize specific user activities.

In certain embodiments, information relating to vendors, products, customers and/or product reviews may be received, determined and/or stored in a structured format. This allows for such information to be searched, filtered and/or employed to compare vendors and/or products offered by any number of vendors. Accordingly, the embodiments may be adapted to determine customized recommendations for vendors relating to, for example, adding, removing and/or customizing products, discounts, workers and/or store locations.

The disclosed embodiments may further allow for dynamic tracking of vendor and/or customer location. Moreover, the embodiments may facilitate management of vendors' relationships with customers and other vendors. Accordingly, the embodiments may facilitate online and/or real-world communication among vendors and/or between vendors and customers. For example, the embodiments may allow a vendor to search for and set up meetings with other vendors.

It will be appreciated that a broad range of products and/or services may be sold through the ecommerce system and/or made available for review by customers. For convenience, such products and services are collectively referred to herein as “products.” Moreover, vendors and service providers are collectively referred to herein as “vendors” for convenience.

The embodiments may be utilized by a number of different types of users, such as but not limited to company/administrative users, third-party vendor users, and customers. The company/administrative users may maintain content and oversee the operation of the ecommerce system and as such, possess administrative privileges. Third-party vendor users may utilize the platform to sell products/services, create profiles, review information, offer discounts, etc. Customers may utilize the platform to search for vendors, leave reviews or details of experiences with vendors, find discounts, etc.

In certain embodiments, customers who possess a level of expertise in a particular field of vendors (e.g., influencers) may be provided with additional types of parameters being evaluated. Influencers may also have separate permissions and rewards structures. According to various embodiments, any of such users may perform one or more searches within the system. These example categories of users may be collapsed together into fewer categories, they may overlap, or they may be broken into additional categories. It should be appreciated that these are merely non-limiting examples.

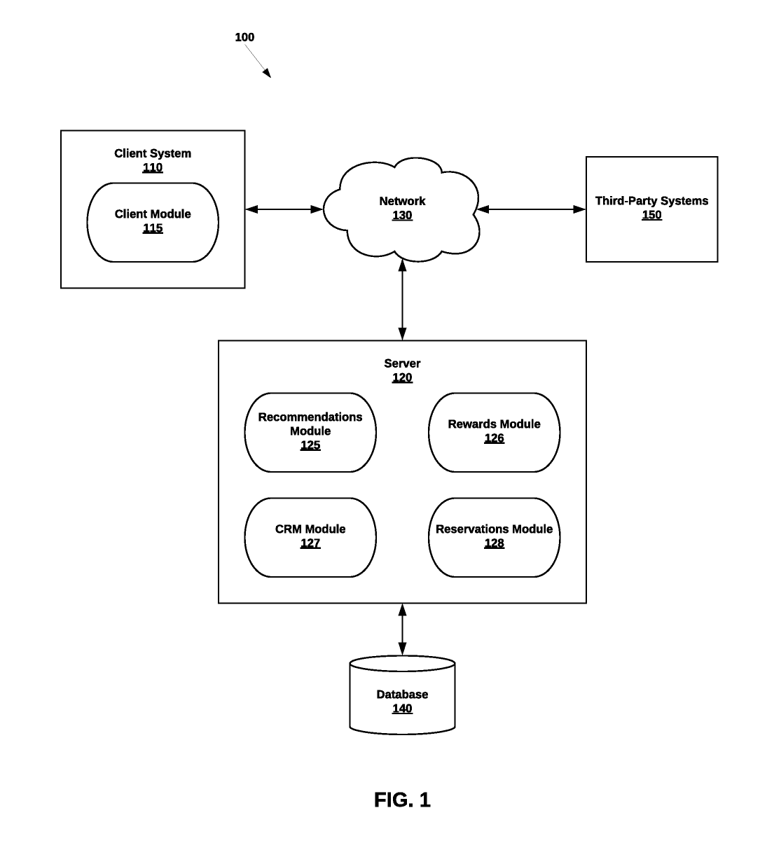

Referring to FIG. 1, a block diagram depicting an ecommerce system 100 in accordance with one or more embodiments is illustrated. As shown, the system may comprise one or more client devices and/or client systems 110 interfacing with a server 120 that transmits and/or receives data to/from a database 140. Each of the client system 110, the server 120 and the database 140 may communicate over one or more networks (e.g., network 130).

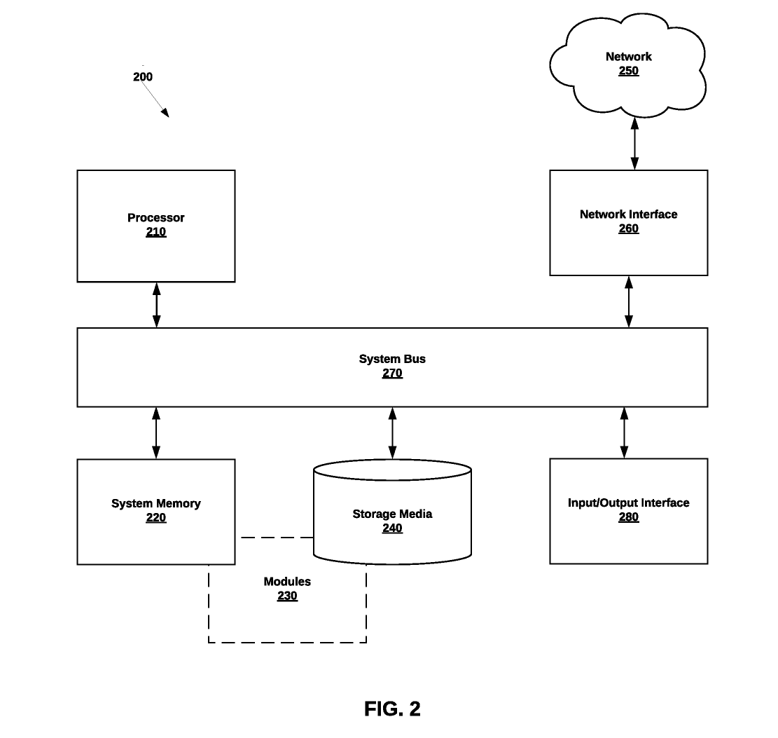

As detailed below in reference to FIG. 2, the server 120 may comprise any number of computing machines and associated hardware/software, where each computing machine may be located at one site or distributed across multiple sites and interconnected by a communication network. The server 120 may provide the backend functionality of the ecommerce system 100.

To that end, the server 120 may execute a multitenant ecommerce application comprising various modules, such as a recommendation module 125, a rewards module 126, a customer relations management module 127 and a reservations module 128. The ecommerce application may be adapted to present various user interfaces to users, where such interfaces may be based on information stored on a client system 110 and/or received from the server 120. The ecommerce application may be written in any form of programming language, including compiled or interpreted languages, or declarative or procedural languages, and it can be deployed in any form, including as a standalone program or as a module, component, subroutine, or other unit suitable for use in a computing environment. Such software may correspond to a file in a file system. A program can be stored in a portion of a file that holds other programs or data. For example, a program may include one or more scripts stored in a markup language document; in a single file dedicated to the program in question; or in multiple coordinated files (e.g., files that store one or more modules, sub programs, or portions of code).

Generally, client systems 110 may comprise any systems or devices capable of running a client module 115 and/or of accessing the server 120. As discussed below in reference to FIG. 2, exemplary client systems 110 may comprise computing machines, such as general purpose desktop computers, laptop computers, tablets, smartphones wearable devices, virtual reality (“VR”) devices and/or augmented reality (“AR”) devices.

The client module 115 may be adapted to communicate with the ecommerce application and/or the various modules running on the server 120. Exemplary client modules 115 may comprise a computer application, a native mobile application, a webapp, or software/firmware associated with a kiosk, set-top box, or other embedded computing machine. In one embodiment, a user may download an application comprising a client module 115 to a client system (e.g., from the Google Play Store or Apple App Store). In another embodiment, a user may navigate to a webapp comprising a client module 115 using an internet browser installed on a client system 110.

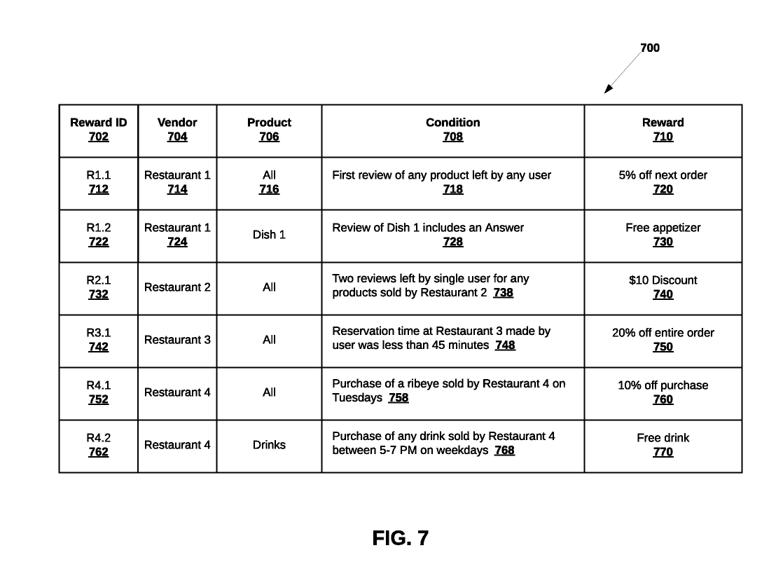

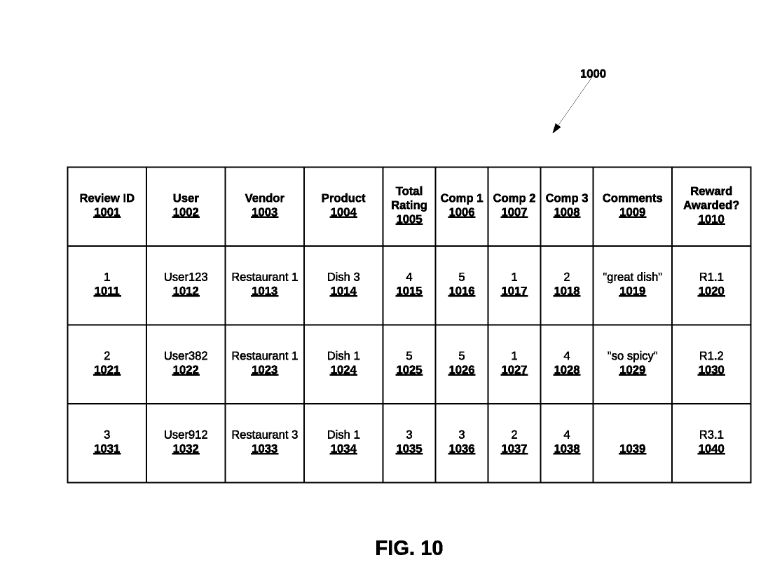

The server 120 and client systems 110 may be adapted to receive and/or transmit application information to/from various users (e.g., via any of the above-listed modules). Such systems may be further adapted to store and/or retrieve application information to/from one or more local or remote databases (e.g., database 140). Exemplary databases 140 may store received data in one or more tables, such as but not limited to, a users table, products table, vendors table, reviews table, rewards table and/or others (see, e.g., FIGS. 7 and 10, below).

Optionally, the ecommerce system 100 may additionally comprise any number of third-party systems 150 connected to the server 120 via the network 130. Third-party systems 150 typically store information in one or more remote databases that may be accessed by the server 120. Third-party systems may include, but are not limited to: nutritional rating systems, payment systems, rating systems, location and navigation systems, backup systems, communication systems and/or others. The server 120 may be capable of retrieving and/or storing information from third-party systems 150, with or without user interaction. Moreover, the server 120 may be capable of communicating information (e.g., information stored in the database 140) to any number of third-party systems, and may notify users of such communications.

Referring to FIG. 2, a block diagram is provided illustrating a computing machine 200 and modules 230 in accordance with one or more embodiments presented herein. The computing machine 200 may correspond to any of the various computers, servers, mobile devices, embedded systems, or computing systems discussed herein. For example, the computing machine 200 may correspond to the client systems 110, server 120 and/or third-party systems 150 shown in FIG. 1.

A computing machine 200 may comprise all kinds of apparatuses, devices, and machines for processing data, including but not limited to, a programmable processor, a computer, and/or multiple processors or computers. As shown, an exemplary computing machine 200 may include various internal and/or attached components such as processor 210, system bus 270, system memory 220, storage media 240, input/output interface 280, and network interface 260 for communicating with a network 250.

The computing machine 200 may be implemented as a conventional computer system, an embedded controller, a laptop, a server, a mobile device, a smartphone, a set-top box, over-the-top content TV (“OTT TV”), Internet Protocol television (“IPTV”), a kiosk, a vehicular information system, one more processors associated with a television, a customized machine, any other hardware platform and/or combinations thereof. Moreover, a computing machine may be embedded in another device, such as but not limited to, a mobile telephone, a personal digital assistant (“PDA”), a smartphone, a tablet, a mobile audio or video player, a game console, a Global Positioning System (“GPS”) receiver, or a portable storage device (e.g., a universal serial bus (“USB”) flash drive). In some embodiments, the computing machine 200 may be a distributed system configured to function using multiple computing machines interconnected via a data network or bus system 270.

The processor 210 may be configured to execute code or instructions to perform the operations and functionality described herein, manage request flow and address mappings, and to perform calculations and generate commands. The processor 210 may be configured to monitor and control the operation of the components in the computing machine 200. The processor 210 may be a general-purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 210 may be a single processing unit, multiple processing units, a single processing core, multiple processing cores, special purpose processing cores, coprocessors, or any combination thereof. In addition to hardware, exemplary apparatuses may comprise code that creates an execution environment for the computer program (e.g., code that constitutes one or more of: processor firmware, a protocol stack, a database management system, an operating system, and a combination thereof). According to certain embodiments, the processor 210 and/or other components of the computing machine 200 may be a virtualized computing machine executing within one or more other computing machines.

The system memory 220 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 220 also may include volatile memories, such as random access memory (“RAM”), static random access memory (“SRAM”), dynamic random access memory (“DRAM”), and synchronous dynamic random access memory (“SDRAM”). Other types of RAM also may be used to implement the system memory. The system memory 220 may be implemented using a single memory module or multiple memory modules. While the system memory is depicted as being part of the computing machine 200, one skilled in the art will recognize that the system memory may be separate from the computing machine without departing from the scope of the subject technology. It should also be appreciated that the system memory may include, or operate in conjunction with, a non-volatile storage device such as the storage media 240.

The storage media 240 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 240 may store one or more operating systems, application programs and program modules such as module, data, or any other information. The storage media may be part of, or connected to, the computing machine 200. The storage media may also be part of one or more other computing machines that are in communication with the computing machine such as servers, database servers, cloud storage, network attached storage, and so forth.

The modules 230 may comprise one or more hardware or software elements configured to facilitate the computing machine 200 in performing the various methods and processing functions presented herein. The modules 230 may include one or more sequences of instructions stored as software or firmware in association with the system memory 220, the storage media 240, or both. The modules 230 may also comprise hardware circuits or information for configuring hardware circuits such as microcode or configuration information for an FPGA or other PLD. Exemplary modules include, but are not limited to, the modules discussed above with respect to FIG. 1 (e.g., the client module 115, recommendation module 125, rewards module 126, customer relations management module 127 and reservations module 128) or any other scripts, web content, software, firmware and/or hardware.

In one embodiment, the storage media 240 may represent examples of machine or computer readable media on which instructions or code may be stored for execution by the processor. Machine or computer readable media may generally refer to any medium or media used to provide instructions to the processor. Such machine or computer readable media associated with the modules may comprise a computer software product. It should be appreciated that a computer software product comprising the modules may also be associated with one or more processes or methods for delivering the module to the computing machine via the network, any signal-bearing medium, or any other communication or delivery technology.

The input/output (“I/O”) interface 280 may be configured to couple to one or more external devices, to receive data from the one or more external devices, and to send data to the one or more external devices. Such external devices along with the various internal devices may also be known as peripheral devices. The I/O interface 280 may include both electrical and physical connections for operably coupling the various peripheral devices to the computing machine 200 or the processor 210. The I/O interface 280 may be configured to communicate data, addresses, and control signals between the peripheral devices, the computing machine, or the processor. The I/O interface 280 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attachment (“ATA”), serial ATA (“SATA”), universal serial bus (“USB”), Thunderbolt, FireWire, various video buses, and the like. The I/O interface may be configured to implement only one interface or bus technology. Alternatively, the I/O interface may be configured to implement multiple interfaces or bus technologies. The I/O interface may be configured as part of, all of, or to operate in conjunction with, the system bus 270. The I/O interface 280 may include one or more buffers for buffering transmissions between one or more external devices, internal devices, the computing machine 200, or the processor 210.

The I/O interface 280 may couple the computing machine 200 to various input devices including mice, touch-screens, scanners, biometric readers, electronic digitizers, sensors, receivers, touchpads, trackballs, cameras, microphones, keyboards, any other pointing devices, or any combinations thereof. When coupled to the computing device, such input devices may receive input from a user in any form, including acoustic, speech, visual, or tactile input.

The I/O interface 280 may couple the computing machine 200 to various output devices such that feedback may be provided to a user via any form of sensory feedback (e.g., visual feedback, auditory feedback, or tactile feedback). For example, a computing device can interact with a user by sending documents to and receiving documents from a device that is used by the user (e.g., by sending web pages to a web browser on a user's client device in response to requests received from the web browser). Exemplary output devices may include, but are not limited to, displays, speakers, printers, projectors, tactile feedback devices, automation control, robotic components, actuators, motors, fans, solenoids, valves, pumps, transmitters, signal emitters, lights, and so forth. And exemplary displays include, but are not limited to, one or more of: projectors, cathode ray tube (“CRT”) monitors, liquid crystal displays (“LCD”), light-emitting diode (“LED”) monitors and/or organic light-emitting diode (“OLED”) monitors.

Embodiments of the subject matter described in this specification can be implemented in a computing machine 200 that includes one or more of the following components: a backend component (e.g., a data server); a middleware component (e.g., an application server); a frontend component (e.g., a client computer having a graphical user interface (“GUI”) and/or a web browser through which a user can interact with an implementation of the subject matter described in this specification); and/or combinations thereof. The components of the system can be interconnected by any form or medium of digital data communication, such as but not limited to, a communication network.

Accordingly, the computing machine 200 may operate in a networked environment using logical connections through the network interface 260 to one or more other systems or computing machines 200 across the network 250. The network 250 may include wide area networks (“WAN”), local area networks (“LAN”), intranets, the Internet, wireless access networks, wired networks, mobile networks, telephone networks, optical networks, or combinations thereof. The network 250 may be packet switched, circuit switched, of any topology, and may use any communication protocol. Communication links within the network 250 may involve various digital or an analog communication media such as fiber optic cables, free-space optics, waveguides, electrical conductors, wireless links, antennas, radio-frequency communications, and so forth.

The processor 210 may be connected to the other elements of the computing machine 200 or the various peripherals discussed herein through the system bus 270. It should be appreciated that the system bus 270 may be within the processor, outside the processor, or both. According to some embodiments, any of the processor 210, the other elements of the computing machine 200, or the various peripherals discussed herein may be integrated into a single device such as a system on chip (“SOC”), system on package (“SOP”), or ASIC device.

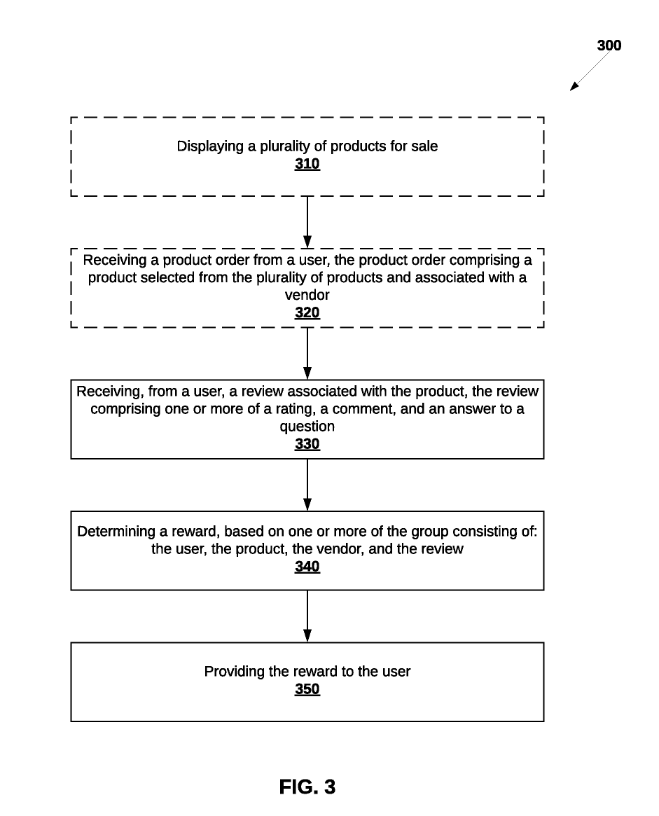

Referring to FIG. 3, a method for providing activity-based rewards to users of an ecommerce platform is illustrated. At step 310, the ecommerce system displays one or more products that may be purchased by customers.

Exemplary products may include, but are not limited to: household products; food and beverage products; electronics (e.g., computers, TVs, audio equipment, etc.); clothing; baby products; arts and crafts products; beauty and personal care products; entertainment products (e.g., books, CDs, DVDs, digital music and video, etc.); automotive products; toys and games; tools and home improvement products; gift cards; courses; gift cards; office products; tickets; outdoor products; pet products and others. And exemplary services may include but are not limited to: delivery services; cleaning services; repair and/or maintenance services; installation services; educational services; professional services (e.g., website design, software development, legal services, etc.); cooking services; care services (e.g., child care services, elderly care services, pet care services, etc.); medical services; beauty and grooming services and others.

At step 320, a product order is received from a customer. The product order may include, or otherwise be associated with: a product selected for purchase by the customer (i.e., a selected product), product information relating to the selected product, user information relating to the customer and/or vendor information relating to the vendor of the selected product.

Generally, product information may include, but is not limited to, a unique product ID; a product name; a description; one or more images; a product category or type (e.g., food, automotive, clothing, tools, etc.); a price; one or more rewards; one or more vendors; shipping or delivery information; and/or one or more product components, ingredients and/or properties (referred to herein as “product components”). As used herein, the terms “food” or “food item” refers to any food or beverage product that may be consumed by a human or animal.

Exemplary product components may include, for example, physical properties (e.g., dimensions, weight, materials, color, etc.); parts or ingredients; and/or various subjective properties (e.g., taste, texture, smell, sound, feel, mouthfeel, value, quality, durability, etc.). In one specific embodiment where food products are sold through the ecommerce system, exemplary product components may include ingredients, flavor profile information (e.g., salty, sweet, savory, bitter, umami, etc.), taste, texture, mouthfeel, portion size, dietary information (e.g., calories, allergens, dietary restrictions, etc.), presentation, price a customer is willing to pay for the product and/or add-ons/features, temperature, smell, others and/or combinations thereof. It will be appreciated that any or all of such information may be received from one or more users of the system and/or may be automatically determined.

Exemplary user information may include, but is not limited to, a name, username, password, location, phone, email address, age, gender, product preferences, vendor preferences and/or payment information. User information may further include user activity information relating to one or more product orders (i.e., order history), one or more product reviews (i.e., reviews history), and one or more reservations (i.e., reservation history). Each user of the ecommerce system (and any/all corresponding user information) may be associated with a user profile that is stored in the database. And it will be appreciated that the system may receive user information from one or more users and/or may automatically determine such information.

In certain embodiments, a user may be provided with an opportunity to control whether the system collects specific user information (e.g., information about a user's social network, social actions or activities, profession, a user's preferences, or a user's current location). A user may be permitted to control whether and/or how information is received from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Finally, exemplary vendor information may include, but is not limited to, a name, phone, email address, location(s), description, images, hours of operation, one or more product(s) offered, one or more reviews and/or ratings, vendor type or category, payment information, shipping or delivery information, target personnel information, and others. In one exemplary embodiment where the vendor is a restaurant, exemplary vendor information may include, for example, menu offerings (i.e., one or more food products), type of cuisine offered, overall rating, general price range, etc.

Steps 310 and 320 represent optional steps in the method. The ecommerce system may allow users to review a product without having made a purchase or order of the product through the system.

At step 330, a review of the product is received from the user. Generally, reviews may comprise one or more ratings, comments, and/or answers to questions. Each of the ratings may be provided in the form of a numerical value (e.g., a scale from 1-5 or 1-10) and may pertain to the product, the vendor and/or to various product components (e.g., quality, price, availability, flavor profile, etc.).

In certain embodiments, the system may provide a review interface to display product- and/or vendor-specific questions to the user. For example, the review interface may display questions asking the user to rate specific product components and/or to confirm product component information provided by vendors or other users. The questions may be received from various users and/or may be automatically generated by the system. And any answers to such questions may be employed by the system to provide product recommendations (discussed below).

In one particular embodiment where a review for a restaurant or food product is received, such review may relate to the restaurant, the food product and/or any number of food product components. In such embodiment, the review may include one or more ratings, comments and/or answers to questions relating to the restaurant, food product and/or food product components. For example, the review may include a question pertaining to what price the user would pay for the menu item. In the case where the review includes a rating of a food product component, such rating may include information about the importance of such component to the user. In this way, the user's ratings may be weighted appropriately in order to provide product recommendations (discussed below).

At step 340, a reward is determined by the system. Generally, one or more rewards may be provided to users upon the occurrence of one or more conditions relating to user activity. As further detailed below, the reward conditions may be conditioned based on one or more of: user information, product information, vendor information and review information.

A number of different types of rewards are within the scope and spirit of the present application. For example, rewards may be discounts, a refund of the order price or a portion thereof, or an amount of money based on the difference between the corresponding order price and a current product price. The reward may be an additional unit of the product, another product altogether, or a gift certificate for a product. The reward may also comprise the establishment and/or adjusting of an account balance with redeemable points.

Potential rewards may be stored in a rewards database described further in FIGS. 7 and 10. Generally, each of the rewards may be associated with one or more conditions relating to any number of user activities, such as but not limited to purchasing products, making reservations within a certain length, and/or leaving product reviews. Moreover, the reward conditions may be customized for individual users (i.e., user-specific rewards), vendors (i.e., vendor-specific rewards) and/or products (i.e., product-specific rewards). In selecting or determining a reward, the server can analyze a user's order history and/or review history to determine whether a particular review condition has been met.

Exemplary user-specific reward conditions may include, for example, a first order of any product by a given user; a milestone reached by a given user (e.g., ten products ordered and/or reviewed by the user); a first review of any product by a user; a first rating of a product component by a specific user; and/or a first answer provided in a review by the user. Exemplary vendor-specific reward conditions may include, for example, a first order of any product sold by a given vendor; a vendor-specific milestone reached by a given user (e.g., twenty vendor-specific products purchased and/or reviewed by the user); a first review of any product sold by the vendor; a first rating of a product component of a product sold by the vendor; and/or a first answer provided in a review relating to a product sold by the vendor. And exemplary product-specific reward conditions may include, for example, a first order of a given product by a user (or by a specific user); an order of a product on a given day (e.g., purchase of a ribeye on Tuesday) or during a certain time (e.g., half off drinks between 5 PM to 7 PM on weekdays); a milestone reached for a specific product by a user (or by a specific user); a first review of the product by a user (or by a specific user); a first rating of a product component of the product by a user (or by a specific user); and/or a first answer provided in a review relating to the product.

At step 350, the system provides information about the selected reward to the user. In one embodiment, the system may transmit a reward notification comprising reward information to the user. Generally, a reward notification may comprise an electronic message (e.g., email, SMS, MMS, instant message, push notification, modal, etc.) that is transmitted to the user. The reward notification may be associated with an alert, such as a textual alert (an animation appearing on a screen, an emoji, etc.), an audible alert (e.g., a chime, a ring, etc.) and/or a haptic alert (e.g., a vibration).

The system may be adapted to provide any number of notifications comprising reward information to customers, and the transmittal of such notifications may be based on various conditions. For example, notifications may sent based on conditions, such as: a user has satisfied a reward condition and has received a reward, a previously-obtained reward is nearing expiration, a user is in the vicinity of a vendor where the user can use a previously-obtained reward, a reward or deal is available in a vicinity of a user, a reward or deal available for a limited time to a user, a friend and/or influencer is located in a vicinity of a user, a menu item or restaurant on a user's bookmarked list of restaurants or menu items in a vicinity of the user, a new vendor has just opened in the vicinity of the user, a user finishes a meal to remind the user to rate the meal and/or others.

Although not shown, in certain embodiments, the system may additionally provide vendor notifications to vendor users. For example, the system may provide vendor notifications to a vendor user when: a product order has been received, a product recommendation has been received, a reservation has been received, a product has expired, a product needs to be restocked, a reward condition has been satisfied, a third-party vendor has requested and/or created an interaction with the vendor, etc.

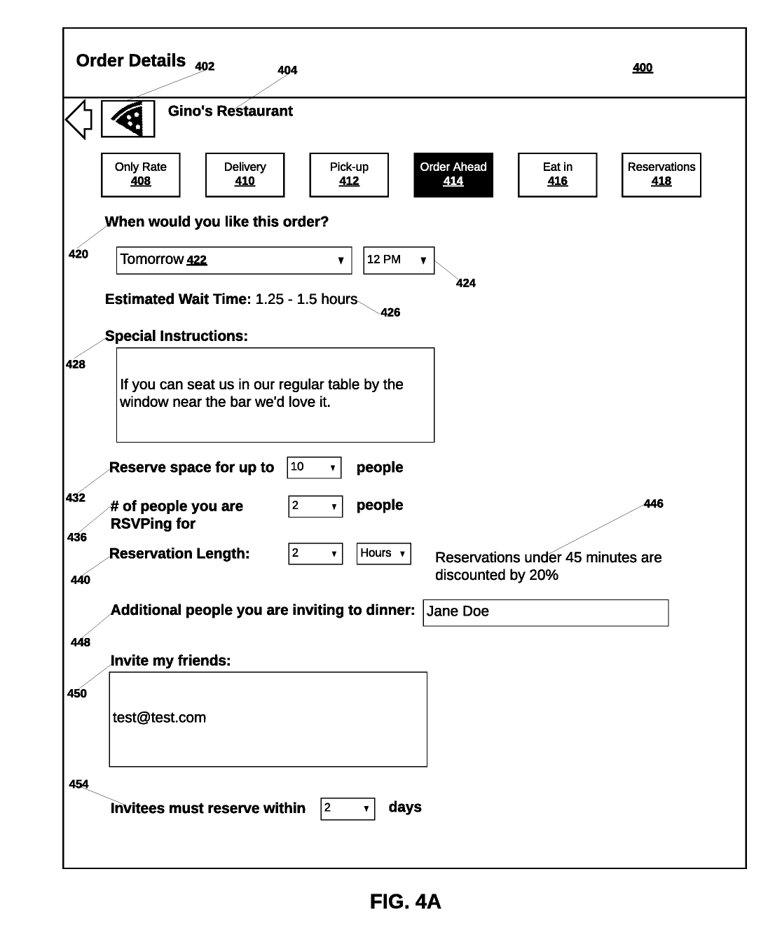

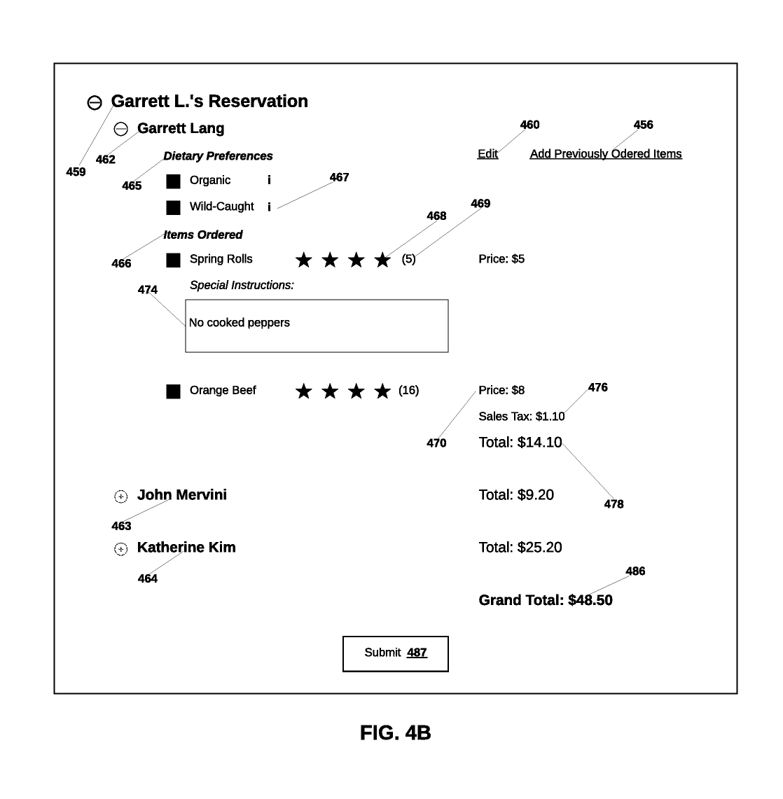

Referring to FIGS. 4A and 4B, an exemplary order details screen 400 according to an embodiment is illustrated. The order details screen 400 allows a customer to order a product from a vendor. Accordingly, in one embodiment, the order details screen may be accessed by selecting a vendor from a list of vendors and/or by utilizing a search function to search for and select a vendor (not shown).

As shown in FIG. 4A, the order details screen 400 displays the name of a selected vendor 404 and an icon associated with the vendor 402. The screen may also display a number of options or links to the user, such as an option to submit a rating for the vendor 408, an option to order delivery 410, an option to order pick-up 412, an option to order ahead 414, an option to eat in 416 and/or an option make a reservation 418. The user may select any of the links by highlighting, single-clicking, double-clicking, tapping, etc.

In the illustrated embodiment, the user has selected the order ahead option 414, which allows the user to create a reservation and/or order food items in advance, at a time specified by a user. As shown, the selected link 414 may be highlighted (e.g., in a font color or background color different from the other, unselected options), and the screen may display order details for the user to customize, review, and submit.

In one embodiment, the screen 400 displays a section asking the user when to create the order 420. The section may include drop-down menus allowing the user to specify a day 422 and time 424 of the order. It will be appreciated that the system may limit the time at which a user may make a reservation, based on various vendor information and/or vendor preferences (e.g., no reservations after a restaurant closes, no reservations more than one month ahead of time, no reservations less than ten minutes before pickup or arrival, etc.)

Upon receiving the user's selection of reservation time, the system may display an estimated wait time 426 for the order to be ready or the reservation to be available. The screen may display additional information based on the selected reservation time, such as an availability of the order, an availability of particular menu items, a next available time within a selected day, daily specials, etc.

The user may additionally be able to submit additional information in a special instructions section 428. The user may, for example, specify information such as preferred seating location, dietary restrictions, the addition of or restriction of one or more ingredients (e.g., no salt), instructions for customizing an order for a special occasion, etc. In other embodiments, the user may, instead of a textual form, be presented one or more selectable options (e.g., “gluten free,” “low fat,” “additional spice,” etc.).

As shown, the user may indicate the maximum number of people to reserve space for 432 and the number of people the user is reserving space for 436 (e.g., via drop-down menus). The user may further indicate reservation length 440 (e.g., hours and/or minutes). Upon the user's selection of the reservation length 440, the screen may display any discounts 446 offered by the restaurant, such as for reservations under a certain amount of time. It will be appreciated that in other embodiments, the screen may display any number of deals/discounts offered by the restaurant (e.g., “Half off dessert items today”), warnings (e.g., “This establishment is smoke free”), and/or announcements (e.g., “We will be open for Labor Day 2018”), which may or may not be customized to the order or the user.

In one embodiment, the system may allow a user to submit contact information for any additional individuals the user is inviting to dinner 448. The system may also allow the user to directly invite additional individuals 450, such as by submitting an email address. And, upon receiving contact information for individuals, the system may send invitations to such individuals with the relevant order details.

In certain embodiments, the user may also indicate a deadline for invited individuals to accept the invitation 454. Upon receiving an invitation from the system, an invited individual may view the order details, including the host (i.e. user who created the order), the vendor, reservation length, individuals invited, individuals who have accepted the invitation, individual orders, amount associated with the order, etc. The individual may choose to accept the invitation as is, decline the invitation, or modify a portion of the invitation (e.g., add special instructions to his order, change items ordered, etc.) and accept it. The host and system may be notified of such changes (e.g., by email). If the invitation expires before the invited individual has submitted a response, the individual might be notified that the invitation has expired and be presented an option to request that the host extend a new invitation. The system may alternatively automatically ask if the host would like to extend the invitation to an invited individual upon expiration of the invitation. Alternatively, the system may automatically close the invitation, and finalize and submit the host's order.

As shown in FIG. 4B, the order details screen 400 may allow the user to add additional order details. The screen may display a collapsible summary of one or more orders 459 created by the user and/or orders 456 previously created by the user. For example, in one embodiment, the details of a created order 459 may be displayed in a collapsible list. Various order information may be displayed for each order in the list, such as but not limited to, names of individuals associated with the order (462, 463, 464) any dietary preferences 465 associated with an individual, menu items that have been ordered by an individual 466, ratings of each menu items 468 and a number of ratings received for each item 469 (e.g., four stars from 5 ratings), a price of each menu item 470, and/or special instructions 474 provided by the user. Additionally, the sales tax 476 associated with the order and the total price of the order 478, including sales tax and individual items ordered may be displayed. In certain embodiments, the grand total 486 of the order created by the user may be displayed and automatically updated upon the addition or removal of menu items and/or individuals associated with an order. In one embodiment, the grand total 486 may be displayed at the bottom of the order details screen.

In certain embodiments, the user may be able to select or hover over a link 467 to view additional information relating to a displayed item (e.g., dietary preferences, menu items, etc.). Upon selecting the link 467, the system may display information such as an explanation of the option or a description of a menu item (e.g., ingredients, preparation time, flavor profile, texture, history, etc.).

In certain embodiments, the system may also the user to rename or otherwise edit an order 460. Additionally or alternatively, the system may allow the user to add a previously ordered item to a given order 456. In any event, upon finalizing the order, the user may select a “Submit” option 487, to submit the order to the system.

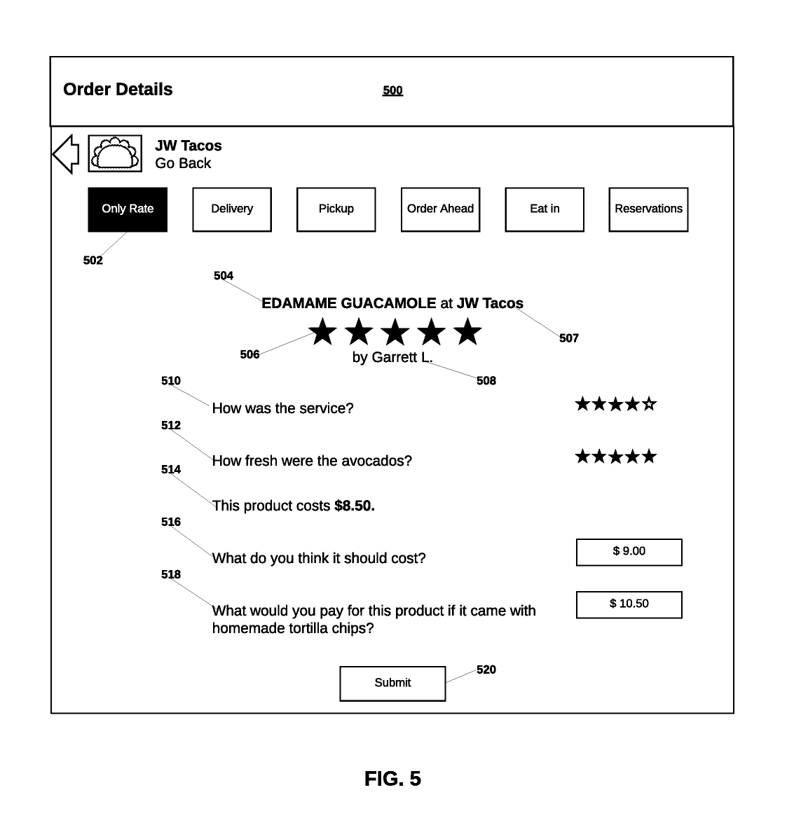

Referring to FIG. 5, an exemplary ratings screen 500 according to an embodiment is depicted. This screen may displayed upon selection of a link 502 allowing a user to only rate a menu item, (e.g., “Only Rate”). In one embodiment, the ratings screen 500 may be displayed when a user selects a previously purchased product (e.g., a menu item)

As shown, the ratings screen 500 allows a user to submit one or more ratings 506 corresponding to a vendor 507, a product 504 (e.g., a menu item) and/or one or more product components. To that end, the system may display various information relating to a selected product, such as the name of the product 504, the vendor associated with the product 507 and/or contact information associated with the vendor. The screen may further display the name 508 of the user providing the rating.

The ratings screen 500 allows a user to enter or select an overall rating 506 for the selected product. In one embodiment, the overall rating 506 may be represented by a five-star scale, with one star representing the lowest rating, and five stars representing the highest rating.

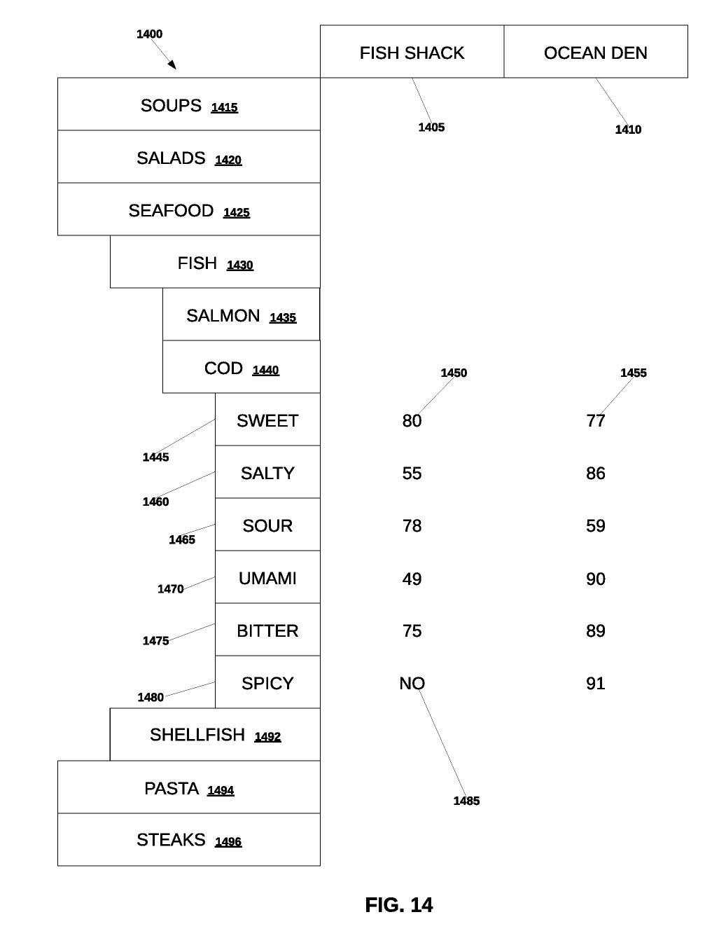

The ratings screen 500 may also allow a user to enter or select a rating for various components related to the selected product. For example, the user may rate the service 510 and/or freshness of certain ingredients (e.g., avocados) 512 of a food item. As discussed below with regards to FIG. 14, the user may also rate the sweet, savory, sour, umami, bitter, and/or spicy components of the food item. The user may provide such information via a five-star rating system and/or via any other method.

In certain embodiments, the ratings screen 500 may further display an actual price 514 associated with the product as well as an option 516 to enter a price that the user would be willing to pay for the product (e.g., if they were to purchase the product again). The user may indicate such price by, for example, positioning a slider on a scale or by entering such price into an input field. The price that the user is willing to pay for a product 516 may account for the user's subjective satisfaction with a given product. For example, such price for a food item may be based on a variety of factors, such as: taste of the food item, ambience of the restaurant where such food item was consumed, and/or level of service provided at the restaurant.

In one embodiment, the user may additionally or alternatively be asked to provide an amount he would be willing to pay for additional or modified product components 518. For example, the illustrated embodiment asks the user what they would pay for the food item if a homemade tortilla was also included. The user may indicate such price by, for example, positioning a slider on a scale or by entering such price into an input field. Although not shown, the user may be asked to provide components that the user would be willing to pay an additional amount for.

Upon entering any of the above information, the user may select a “Submit” option 520 to submit the rating to the system. The system may receive such ratings information and, in certain embodiment, utilize the same to generate recommendations for vendors and/or rewards for the user.

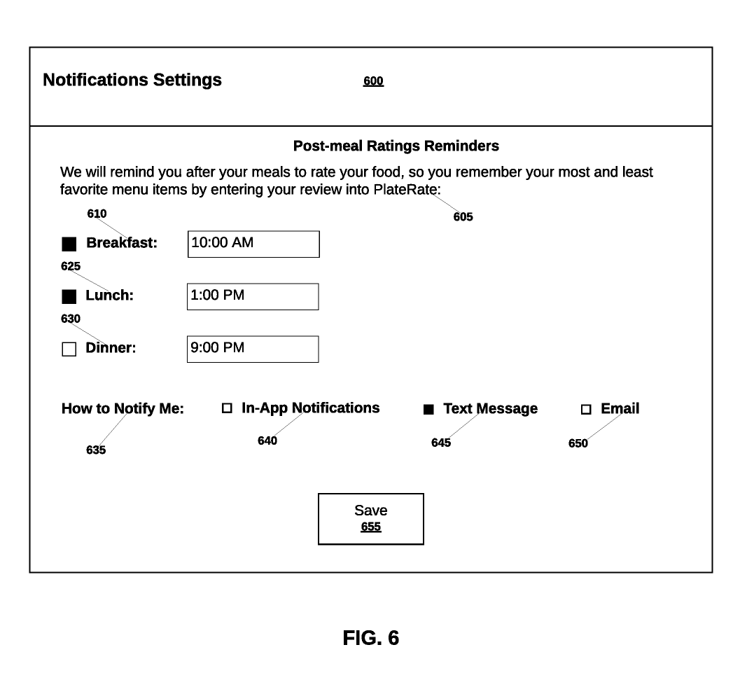

Referring to FIG. 6, an exemplary notifications settings screen 600 according to an embodiment is illustrated. As shown, this screen allows a user to customize settings for notifications relating to the rating of one or more menu items.

In one embodiment, the notifications settings screen 600 may display a description of each reminder 605. The screen may further allow a user to input desired times for receiving various notifications, such as post-breakfast reminders 610, post-lunch reminders 625, and/or post-dinner reminders 630. The app may furthermore allow the user to turn post-meal ratings reminder notifications on/off for each meal (e.g., via a toggle button).

In certain embodiments, the system may allow a user to customize the means through which notifications are transmitted. For example, the settings screen may display various selectable options 635, such as: in-app notifications 640, text messages 645 and emails 650. It will be appreciated that, in other embodiments, additional or alternative notification options may be available (e.g., in-app messages via social media networks and/or messaging applications). Finally, the user may save the notifications settings by selecting a save option 655.

It will be appreciated that additional notifications options may be provided to the user, including but not limited to: customizing the type of notification provided (e.g., visual, sound, haptic, etc.), customizing the intensity or degree of the notification (e.g., a loudness of a sound alert, an intensity of a haptic alert, etc.), customizing notifications by specific day, customizing notifications to alert after dining at a specific restaurant, adding meal times (e.g., a 3 PM snack time) and/or notifications for such meal times.

Referring to FIG. 7, an exemplary rewards database table 700 storing user-activity-based rewards offered by various vendors for any number of products is illustrated. As shown, rewards information for each reward may include, but is not limited to, a unique reward ID 702, a vendor who is offering the reward 704, one or more products associated with the reward 706, one or more conditions relating to one or more user activities and specifying when the reward should be provided to one or more users 708, and/or a reward definition specifying the details of the reward 710.

In the illustrated embodiment, a number of rewards relating to restaurants and food products are shown in the database table 700. For example, Reward R1.1 712 may be provided to a user when the system receives a first review 718 from the user relating to any product 716 offered by Restaurant 1 714. Upon determining that a user has satisfied the condition 718 associated with Reward R1.1 712, the system may associate Reward R1.1 with the user's profile and may provide a notification to the user explaining that their next order of a food product from Restaurant 1 will be discounted by 5% 720. Accordingly, when the user next purchases a qualifying food product via the ecommerce system, the system may automatically apply a 5% discount to the order.

As another example, Reward 1.2 722 may be provided to a user upon writing a review of Dish 1 sold at Restaurant 1 724 which includes an Answer 728. The reward may entail a free appetizer 730. As yet another example, Reward 2.1 732 may be provided to a user when the user submits two reviews for products sold at Restaurant 2 738. The reward may entail a $10 discount 740.

As discussed above with respect to FIGS. 4A and 4B, the system may provide rewards for choosing a reservation length that is less than a predetermined amount of time. This corresponds to Reward 3.1 742, which may be provided to a user upon the creation of a reservation at Restaurant 3 748 with a length that is less than 45 minutes. The reward may entail a discount of 20% off of the entire order 750.

In another example, Reward R4.1 752 may be provided to a user that purchases a specific item (e.g., a ribeye) sold by a specific vendor (e.g., Restaurant 4) on a specific day (e.g., Tuesdays) 758. The reward may entail 10% off the purchase of the ribeye 760. Although not shown, it will be appreciated that the vendor may offer increasingly larger discounts as food items near their expiration dates. For example, if the ribeyes at Restaurant 4 are expiring on Sunday, Restaurant 4 may offer 20% off on Wednesday, 30% off on Thursday, and so on, before the ribeyes are disposed of on Friday or Saturday. Such product- and vendor-specific reward conditions may incentivize a user to purchase time-sensitive (e.g., expiring) food items from vendors and allow for faster turn-over of food items and reduced waste.

As yet another example, rewards may be awarded to users who purchase an eligible item within a certain timeframe on one or more given days. For example, Reward 4.2 762 may be provided to a user that purchases a drink sold by Restaurant 4 between 5 PM and 7 PM on weekdays 768, such as a free drink with the purchase 770.

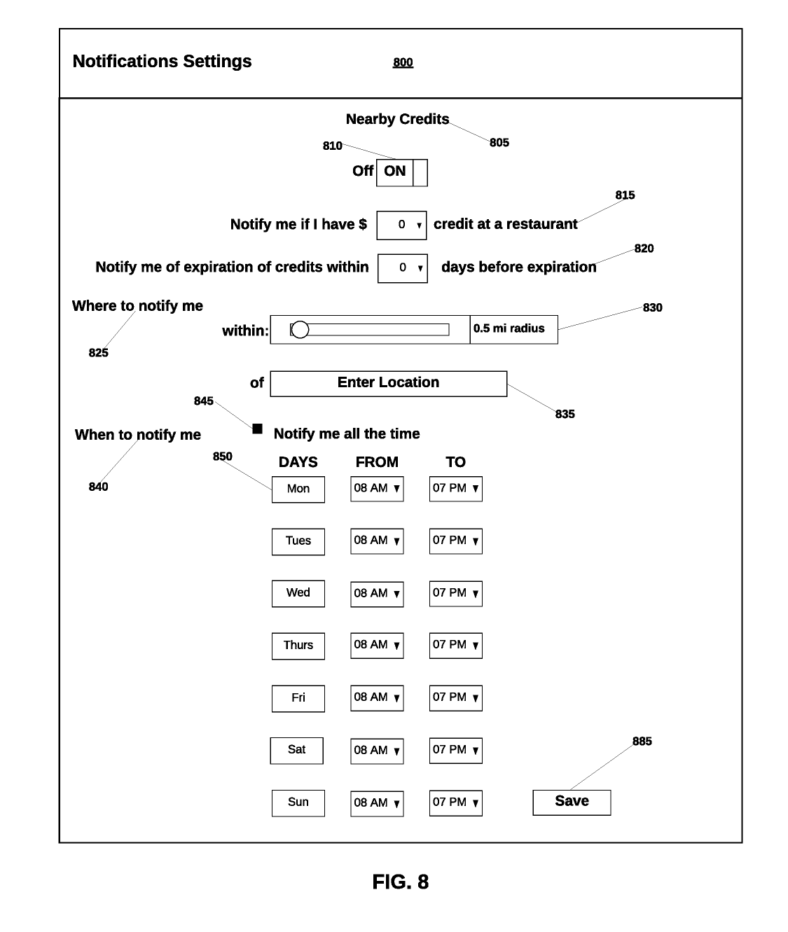

Referring to FIG. 8, an exemplary nearby credits notifications settings screen 800 according to an embodiment is illustrated. As shown, this screen 800 allows a user to customize notifications relating to available credits for vendors in the vicinity of the user 805 (e.g., “Nearby Credits”).

As shown, the user may turn such notifications on or off via a toggle button 810. The user may specify that the app remind the user about unused credits upon reaching a predetermined amount of credits 815 inputted by the user via a menu 812. The user may also request the app to remind the user to use available but expiring credits applicable to a vendor in the vicinity of the user 820. The user may request notification a predetermined amount of time before the credits expire 820, also via a drop-down menu. For example, the user may request notification of expiration of credits within two days before the expiration of the credits.

In a “Where to notify me” section 825, the user may also specify the location 835 and/or the distance 830 from the location (e.g., measured by radius) within which the user would like to be notified of the expiration of credits. In the illustrated embodiment, the user may enter a location in a textual form. In such embodiment, the user may additionally use a slider 830 to specify the distance from the location 835.

The user may also specify the frequency and/or time of day at which to be notified in a

“When to notify me” section 840. In the embodiment shown, the user may select a box 845 allowing the app to notify the user all the time, as long as he is within the predetermined distance specified by the location 835 and radius 830. The user may also specify the times of each day 850 to be notified of nearby credits. For example, the user may specify that, on Mondays, he would like to be notified between the hours of 8 AM and 7 PM. The user may similarly specify the times for every other day of the week. The user may then save the settings for nearby credits by selecting a save option 885.

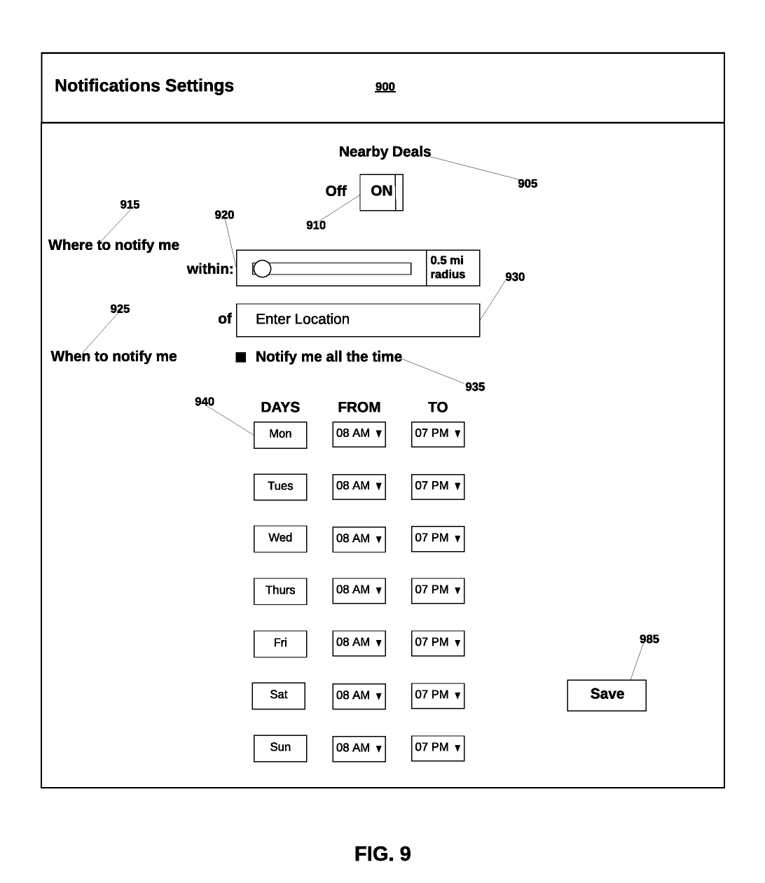

Referring to FIG. 9, an exemplary nearby deals notifications settings screen 900 according to an embodiment is illustrated. As shown, this screen allows a user to customize settings for notifications relating to deals offered by vendors in the vicinity of the user 905.

In one embodiment, the user may turn such notifications on or off via a toggle button 910. The screen 900 may display a “Where to notify me” section 915, which allows the user to specify a location 930 and a distance 920 from such location within which the user would like to be notified of nearby deals. The user may enter the location 930 via an input form field or the system may automatically determine the current location of the user. In one embodiment, the user may additionally use a slider 920 to specify a distance (e.g., “0.5 mile radius”) from the location 930.

The nearby deals notifications settings screen 900 may also allow the user to specify a frequency and time of day to be notified of nearby deals 925. The user may select a box 935 such that the system will notify the user all the time, as long as the user is within the predetermined distance specified by the location 930 and radius 920. Additionally or alternatively, the user may specify the times of each day 940 to be notified of nearby deals. For example, in one embodiment, the user may specify that on Mondays, he would like to be notified between the hours of 8 AM and 7 PM. The user may similarly specify the times for every other day of the week. The user may then select a save option 985 to save the entered settings.

Referring to FIG. 10, an exemplary reviews database table 1000 storing a number of user reviews of products associated with various vendors is illustrated. As shown, the reviews database may store review information for each review received from a user. Such review information may include, but is not limited to, a unique review ID 1001, a user who provided the review 1002, a vendor to whom the review relates 1003, a product to which the review relates 1004, a total or aggregate rating relating to the product 1005, one or more ratings relating to individual product components 1006-1008, any number of comments 1009 and/or any number of corresponding rewards awarded based on the review 1010.

As shown in the illustrated embodiment, Review 1 1011 was left by User123 1012 for Dish 3 1014 sold by Restaurant 1 1013. The user gave the dish a total rating of 4 1015 (e.g., 5 out of a possible 5), and rated Component 1 as a 5 1016, Component 2 as a 1 1017, and Component 3 as a 2 1018. Review 1 also includes a comment (e.g., “great dish” 1019), which may have been provided in answer to a question about the taste of Dish 3. As shown, the system awarded the user Reward R1.1 1020 (e.g., a “5% off next order”) upon receiving Review 1, because the review satisfied the condition of Reward R1.1 (e.g., “first review of any product left by any user”) (see FIG. 7 at 718). Accordingly, when User123 next purchases food products from Restaurant 1 via the ecommerce system, the system may automatically remove 5 percent from the total price of the order.

As another example, Review 2 1021 was left by User382 1022 for Dish 1 1024 sold by Restaurant 1 1023. The user gave the dish a total rating of 5 1025 (e.g., 5 out of a possible 5), and rated Component 1 as a 5 1026, Component 2 as a 1 1027, and Component 3 as a 4 1028. Review 2 also includes a comment (e.g., “so spicy” 1029), which may have been provided in answer to a question about the spiciness of Dish 1. As shown, the system awarded the user Reward R1.2 1030 (e.g., a “free appetizer”) upon receiving Review 2, because the review satisfied the condition of Reward R1.2 (e.g., “review of Dish 1 includes an answer”) (see FIG. 7 at 728). Accordingly, when User382 next purchases food products from Restaurant 1 via the ecommerce system, the system may automatically remove a charge for an appetizer from the total price of the order.

In yet another example, Review 3 1031 was left by User912 1032 for Dish 1 1034 sold by Restaurant 3 1033. The user gave the dish a total rating of 3 1035 (e.g., 5 out of a possible 5), and rated Component 1 as a 3 1036, Component 2 as a 2 1037, and Component 3 as a 4 1038. Review 3 does not include a comment, which may be indicated by an empty space 1039. As shown, the system awarded the user Reward R3.1 1040 (e.g., a “20% off next order”) upon receiving Review 3, because the review satisfied the condition of Reward R3.1 (e.g., “reservation time at Restaurant 3 made by user was less than 45 minutes”) (see FIG. 7 at 748). Accordingly, when User912 next purchases food products from Restaurant 3 via the ecommerce system, the system may automatically remove 20% from the total price of the order.

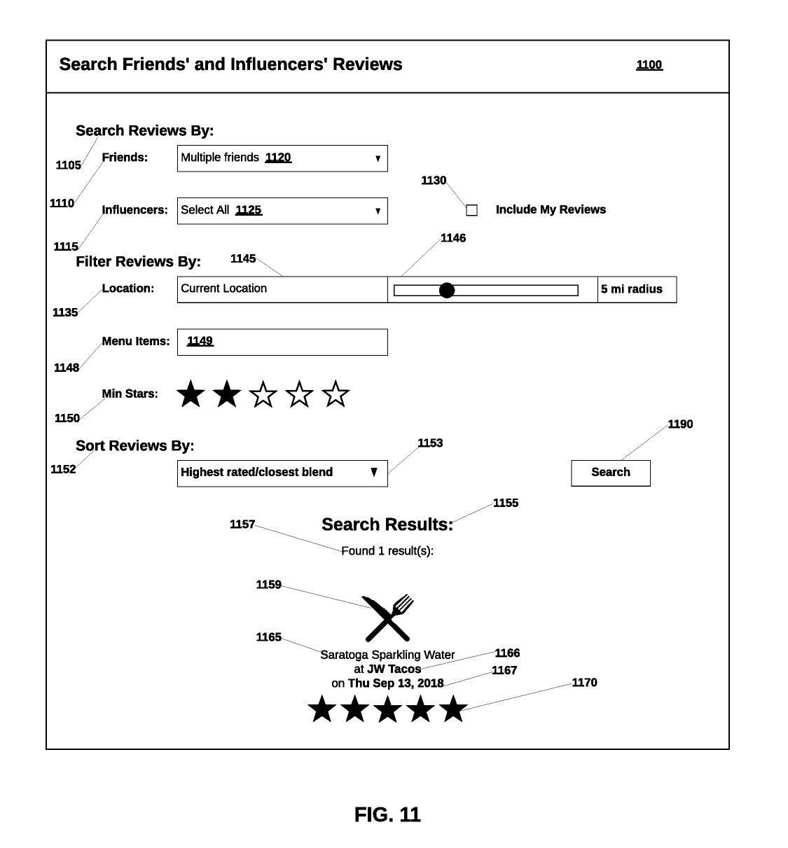

Referring to FIG. 11, an exemplary social review search screen 1100 according to an embodiment is illustrated. As shown, this screen 1100 allows a user to search the system for reviews that have been left by friends and/or influencers.

In one embodiment, the system may maintain a history of every product that each user has rated, including the product information (e.g., geographic location). The system may allow users to search reviews 1105 of friends 1110 and/or influencers (e.g., reviewers with a large “influence,” or following by other users on the app) 1115 by selecting one or both options. The system may further allow users to search the reviews of multiple friends via a drop-down menu 1120. It will be appreciated that the user may similarly search the reviews of multiple or all influencers via a drop-down menu 1125. The system may also allow the user to select whether to include his own reviews in the search 1130.

The system may further allow the user to filter the reviews of his friends and/or influencers 1135 by location. In one embodiment, the location may be the current location of the user 1145. It will be appreciated that the current location may be automatically determined by the application rather than inputted by the user. As shown, the user may additionally position a slider along a scale 1146 indicating a distance from the selected location 1145.

This screen 1100 may allow the user to enter additional filter parameters. For example, the user may input menu information via a textual form 1149 within a menu item information section 1148 (e.g., a name, a texture, a flavor profile, etc.) to further filter the review results. The user may additionally enter a minimum rating 1150 (e.g., a minimum number of stars 1150). And the user may submit the search parameters by, for example, selecting the search option 1190.

Upon receiving the filter parameters, the system may display the matching reviews in a search reviews section 1155. As shown, the screen may display the number of search results returned 1157, a product name 1165 associated with the review, an image 1159 associated with the product, a name of a vendor associated with the product 1166, a date on which the review was received 1167, and/or a rating 1170 associated with the product. Although not shown, additional information may be shown, including but not limited to: a location associated with the vendor, contact information associated with the vendor (e.g., phone number, email, etc.), popular items offered by the vendor and/or user information relating to the user who left the review (e.g., name, image, contact information, etc.).

In one embodiment, the screen 1100 may allow the user to select the order in which results are shown 1152. For example, screen may allow the user to select from multiple sorting options, including a mixture of the highest rated and most relevant results 1153, meaning that the highest rated and most relevant items will be shown first. Other options may include, but are not limited to: highest rated only, most relevant results only, nearest vendors only, friends with the most mutual friends only, and/or a combination of the above.

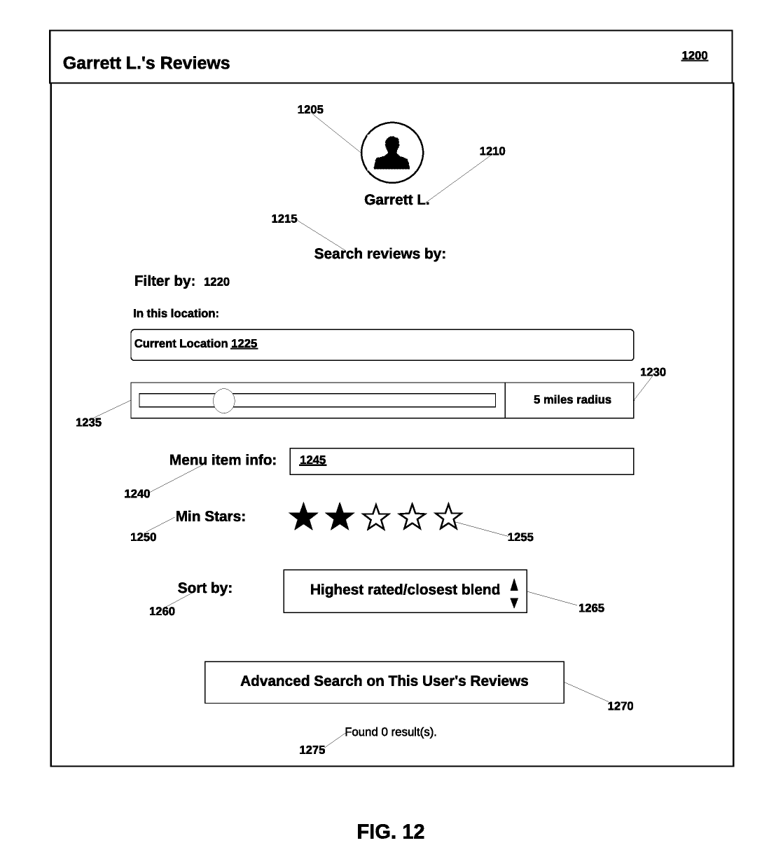

Referring to FIG. 12, an exemplary user reviews screen 1200 according to an embodiment is illustrated. As shown, this screen allows a user to perform a search 1215 of all reviews associated with a specific user (i.e., a reviewer). As discussed above, as with the social review search screen 1100, the user may search and filter results via the user reviews screen 1200.

As shown, this screen may display a name 1210 and a photo 1205 associated with the reviewer whose reviews are being searched. In certain embodiments, the displayed name and/or photo may be selected by the reviewer and may be associated with the reviewer's profile stored in the database. Although not shown, the app may display additional details associated with the reviewer, such as age, gender, contact information, favorite restaurants, bookmarks, recently reviewed products, etc.

The system may further allow the user to filter the reviews of his friends and/or influencers 1220 by location. In one embodiment, the location may be the current location of the user 1225. It will be appreciated that the current location may be automatically determined by the application rather than inputted by the user. As shown, the user may additionally position a slider along a scale 1235 indicating a distance from the selected location 1230.

This screen 1200 may allow the user to enter additional filter parameters. For example, the user may input menu information via a textual form 1245 within a menu item information section 1240 (e.g., a name, a texture, a flavor profile, etc.) to further filter the review results. The user may additionally enter a minimum rating 1250 (e.g., a minimum number of stars 1255). And the user may submit the search parameters by, for example, selecting the search option 1270.

Upon receiving the filter parameters, the system may display the matching reviews in a search reviews section 1275. The screen may display the number of search results returned 1275. Although not shown, it may also show a product name associated with the review, an image associated with the product, a name of a vendor associated with the product, a date on which the review was received, and/or a rating associated with the product. Additional information may be shown, including but not limited to: a location associated with the vendor, contact information associated with the vendor (e.g., phone number, email, etc.), popular items offered by the vendor and/or user information relating to the user who left the review (e.g., name, image, contact information, etc.).

In one embodiment, the screen 1200 may allow the user to select the order in which results are shown 1260. For example, screen may allow the user to select from multiple sorting options, including a mixture of the highest rated and most relevant results 1265, meaning that the highest rated and most relevant items will be shown first. Other options may include, but are not limited to: highest rated only, most relevant results only, nearest vendors only, friends with the most mutual friends only, and/or a combination of the above.

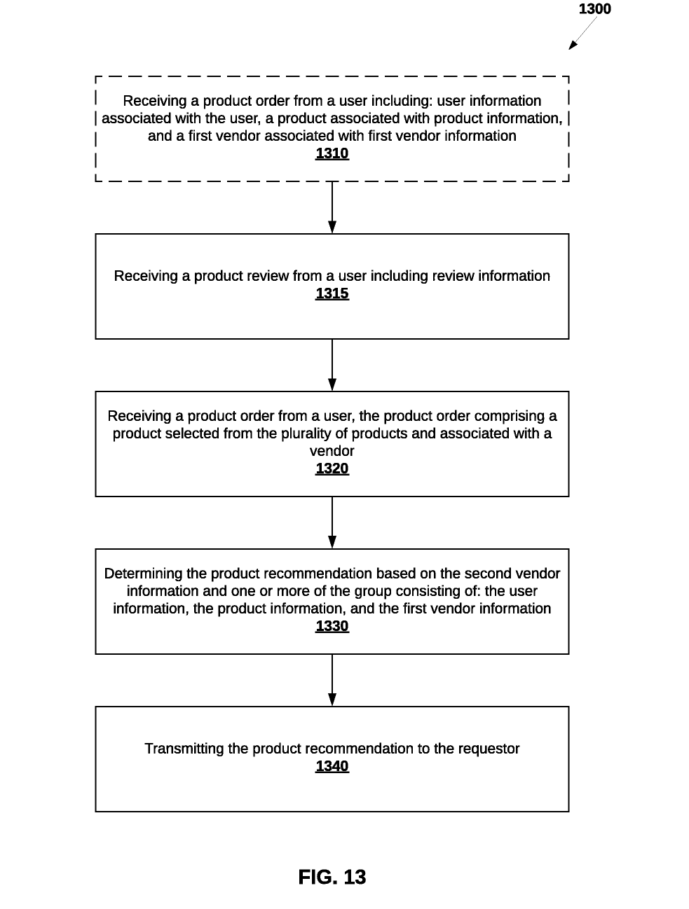

Referring to FIG. 13, a method 1300 for providing customized product recommendations based on user activity information is illustrated. At optional step 1310, one or more product orders are received from one or more users. Each of the product orders may include, or otherwise be associated with, product information relating to one or more products ordered by a user, user information relating to the purchasing user and/or vendor information relating to a vendor of each of the one or more products. It will be appreciated that any number of product orders may be received from any number of users, and some or all information relating to such orders may be employed by the system to determine product recommendations.

At step 1315, one or more reviews relating to the ordered product(s) are received from one or more users. As discussed above, each of the reviews may include, or otherwise be associated with, review information, such as ratings of products and/or product components, answers to questions and/or comments. It will be appreciated that any number of reviews may be received from any number of users and some or all review information associated with such reviews may be employed by the system to determine product recommendations.

At step 1320, the system receives a request to determine a product recommendation from a requestor, such as but not limited to a data steward, administrator, manager, and/or a user associated with a vendor. The request may include request information comprising a vendor (i.e., a “second vendor” or “selected vendor”) associated with vendor information (i.e., “second vendor information” or “selected vendor information”) and to which the requested recommendation will correspond. Additionally, the request information may optionally include one or more request parameters or filters that may be employed to limit product recommendations. Exemplary request parameters may include, but are not limited to, vendor type or category (e.g., selected vendor type, selected vendor category, etc.); vendor location (e.g., locations within a certain distance of the selected vendor's location); product information relating to one or more products offered by the selected vendor (e.g., product name, product type or category, product price, product component(s), etc.); vendor and/or product ratings (e.g., minimum and/or maximum ratings); vendor and/or product popularity (e.g., minimum number of orders, minimum number of reviews, etc.); and other information and/or combinations thereof.

Generally, the request may be received from a requestor via a product recommendation request interface. Such interface may provide various options to the requestor to allow for the input and/or selection of request information. In certain embodiments, available request parameters may be displayed to the requestor based on vendor information of the selected vendor. That is, upon receiving a selected vendor, the system may display various parameters corresponding to vendor information associated with the selected vendor and/or product information associated with products offered by the selected vendor. For example, relevant parameters may be displayed to allow the requestor to include or exclude one or more of: particular vendors based on vendor information and/or review information, and/or particular products and/or product components based on product information and/or review information. In some embodiments, the product recommendation request interface may allow the requestor to sort vendors, products and/or product component parameters by rating, location or other criteria.

At step 1330, the system determines a product recommendation. And at step 1340, the system displays the product recommendation to the requestor.

Generally, product recommendations may be based on the selected vendor information, any optional request parameters, and one or more of the group consisting of: user information corresponding to users who have purchased and/or reviewed (1) products offered by the selected vendor and/or vendors that are similar to the selected vendor and/or (2) products that are offered by vendors other than the selected vendor and that are similar to products offered by the selected vendor; product information (optionally, including product component information) corresponding to such products; and/or review information corresponding to reviews of such products.

In one particular embodiment, the system may determine a product recommendation by first comparing the selected vendor to other vendors stored in the system in order to determine vendors that are similar to the selected vendor (“similar vendors”). The system may determine that a given vendor is similar to the selected vendor based on a comparison of some or all of the vendor information of both vendors. For example, a given vendor may be determined to be a similar vendor to a selected vendor when the vendor's location is within a predetermined distance from the selected vendor's location and the vendor's type matches that of the selected vendor. As another example, a given vendor may be determined to be a similar vendor to a selected vendor when the vendor is associated with at least a predetermined number of similar or identical products (e.g., at least 1 similar product, at least 2 similar products, at least 3 similar products, at least 4 similar products or at least 5 similar products).

Upon determining one or more similar vendors to the selected vendor, the system may proceed to comparing products offered by the similar vendors to products offered by the selected vendor in order to determine a product recommendation. For example, if a similar vendor offers a product that the selected vendor does not offer, and that product matches any of the optional request parameters (e.g., exceeds a minimum purchase and/or minimum rating threshold) the system may recommend that the selected vendor offer the product.

In one embodiment, the system may compare product information associated with products offered by the selected vendor and products offered by similar vendors to determine whether any of such products are similar (i.e., “similar products”). The system may make such a determination based on any product information, such as but not limited to, product name, product category (e.g., appetizers, desserts, pastries, savory foods), product type (e.g., Italian food, Chinese food, etc.), product components (e.g., cod, chicken, taste, presentation), price and/or product or product component ratings.

If any similar products are found, the system may determine whether such products match any default and/or optional request parameters (e.g., a similar product is purchased more often than a selected vendor's product or a similar product is associated with a higher rating than a selected vendor's product). Upon determining that a similar product matches such parameters, the system may then compare product component information associated with both products in order to determine a product recommendation.

As an example, consider that a selected vendor and a similar vendor are both Japanese restaurants in New York City that offer salmon bento boxes. Consider further that the selected vendor's salmon bento box is poorly rated, rarely purchased and does not come with any sides, while the similar vendor's bento box is highly rated, often purchased and comes with a side of soba noodles. In such a case, the system may recommend that the selected vendor include a soba noodle side with its bento box.

As another example, consider that a selected vendor and a similar vendor are both Italian restaurants in Boston, Mass. that offer fettuccini alfredo. Consider further that the selected vendor's fettuccini is associated with a “salty” rating of 1 out of 5 and an overall rating of 3 out of 5, while the similar vendor's fettuccini is associated with a “salty” rating of 4 out of 5 and an overall rating of 5 out of 5. In this case, the system may recommend that the selected vendor add more salt to their fettuccini alfredo dish.

In one particular embodiment where a review of a similar product includes a suggested price, the system may determine a product recommendation relating to a selected vendor's product based on such pricing information. The system may additionally or alternatively provide a product recommendation relating to one or more product components of the selected vendor's product based on the pricing information and any other review information that indicates which product components are the most important and/or valuable to users.

In other embodiments, the determination of a product recommendation may additionally or alternatively be based on other user activity information, such as but not limited to, highly-rated reviews of a product or a product component, user views of products and/or product reviews, user check-ins to various vendors, click-through activity, browsing activity, shopping cart contents, abandoned shopping cart contents, and/or bookmarked products or vendors. Each product recommendation determination may weigh implicit user interactions differently than explicit user interactions. To further tailor the recommendations, the system may employ user-specified preferences such as user-assigned weights or ratings relating to the importance of certain product components. Users may assign these weights or ratings through user surveys, through user profiles, etc.

In one embodiment, the product recommendation may comprise a list of one or more recommendations. Such list may be sorted from highest relevance to lowest relevance, for example using review information associated with various product components. The sorting may additionally or alternatively determine relevance based on user-selected weights indicating a user's affinity for, or current interest in, various products and/or product components. For example, products that have been ordered many times and/or that have been recently ordered may be weighted more than products that have been ordered less frequently and/or less recently. In any event, the product recommendations may be automatically updated (e.g., on a daily or weekly basis) as additional orders and/or reviews are received.

Referring to FIG. 14, an exemplary product recommendation interface 1400 according to an embodiment is illustrated. As shown, the user interface 1400 may display product information associated with products offered by a selected vendor 1405 and/or similar products offered by one or more similar vendors 1410. Such interface may be utilized in accordance with various systems and methods discussed herein for viewing product recommendations.

In one embodiment, the recommendation interface 1400 may comprise a tree structure including nodes and leaves that may be assembled into a logical, organized structure. The elements of the tree structure may be mutually exclusive and categorically exhaustive (“MECE”). Generally, the tree structure may contain pointers to review information relating to the various product components. Such review information may correspond to one or more reviews received from various users.

More specifically, the tree structure may provide vendor information and product information (e.g., including product components and relevant ratings) used in comparing products of a selected vendor to similar products offered by similar vendors in order to determine product recommendations.

As shown in the illustrated embodiment, the tree structure includes products offered by a selected vendor 1405 and similar products offered by a similar vendor 1410. Such products fall into a number of product categories, include “soups” 1415, “salads” 1420, “seafood” 1425, “pasta” 1494, and “steaks” 1496. The “seafood” 1425 category contains a number of product types, including “fish” 1430 and “shellfish” 1492. And the “fish” 1430 category includes specific products, including “salmon” 1435 and “cod” 1440.

As further shown, the “cod” 1440 product of the selected vendor and the “cod” product of the similar vendor are both associated with a number of product components, including “sweet” 1445, “salty” 1460, “sour” 1465, “umami” 1470, “bitter” 1475 and “spicy” 1480. And each of such product components are further associated with an aggregate or average rating. For example, the “sweet” 1445 component of a cod dish may be assigned a first aggregate value 1450 (e.g., “80”) at the selected vendor 1405 and a second aggregate value 1455 (e.g., “77”) at the similar vendor 1410. The value may indicate satisfaction level, or level of sweetness present in the cod as experienced by the reviewers. As another example, the “spicy” 1480 component of the cod dish may be assigned a value of “NO” 1485 at the selected vendor 1405, indicating no reviews have been received for the “spicy” component. In this way, the system may allow for products and/or product components to be compared across any number of vendors and for product recommendations to be determined for such products and vendors.

It will be appreciated that additional nodes relating to other vendor information, review information and/or product information may be displayed. Indeed, the contents of the intersection between a leaf/node and a second dimension object (such as a vendor in the previous example), can provide comparative information in the form of text descriptions, rankings, scores, values, calculated values, ranges, limits, or other content types.

In certain embodiments, the tree structure can evolve based on the input and feedback of many users. Certain users may extend the parameters to be compared for a given type of vendor. Furthermore, multiple users can access and update data. Accordingly, the data may be constantly improved upon. Users of the system may leverage the ever-improving data sets. Users can curate the versions of the data sets to present only the most refined, appropriate, or desirable version. Users designated as data stewards may determine these data sets or establish the criteria for doing so. A dynamic tree-structure may be compared rigorously across various options using user input and feedback.

It will be appreciated that while an example of comparing vendors, products and/or product components is used for illustrative purposes herein, the present technology may be used to compare any set of criteria x₁ . . . xₙ to any set of other criteria y₁ . . . yₘ. Such comparison may include representing y₁ . . . yₘ along one graphical axis to further compare against another criteria z₁ . . . zₖ. Additional such comparisons across additional dimensional axes can be be continued as required by the situation.

It will be further appreciated that, although one exemplary product recommendation interface is shown, various alternative embodiments may employ a different interface without departing from the spirit or scope of the technology presented herein. For example, the interface may comprise graphs, graph databases, sets, lists, pointers, grids, arrays, multidimensional arrays, hashes, and/or any other framework for structuring data or representing relationships.

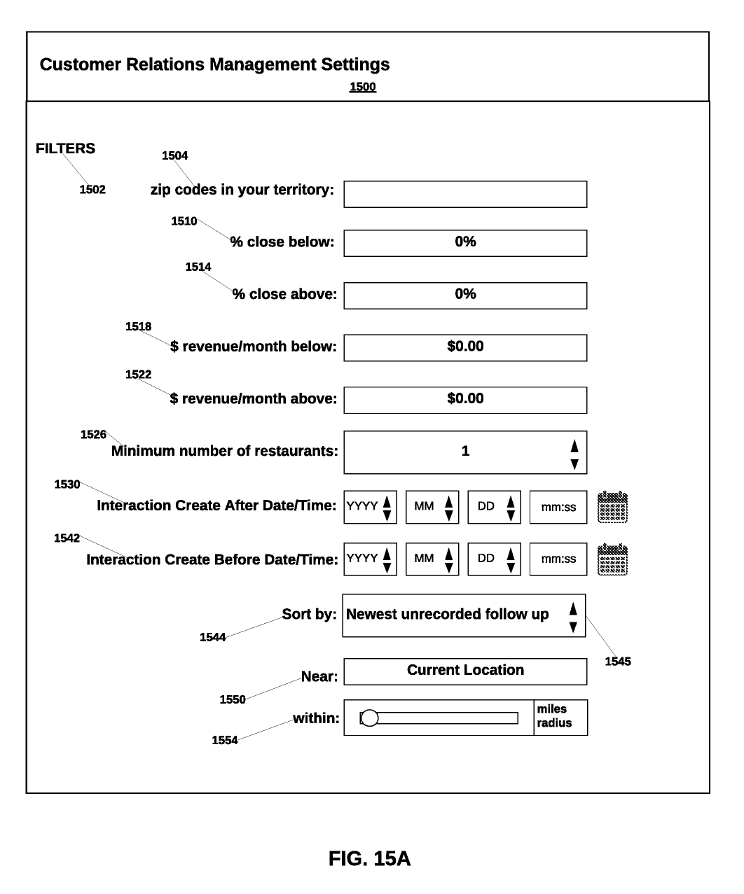

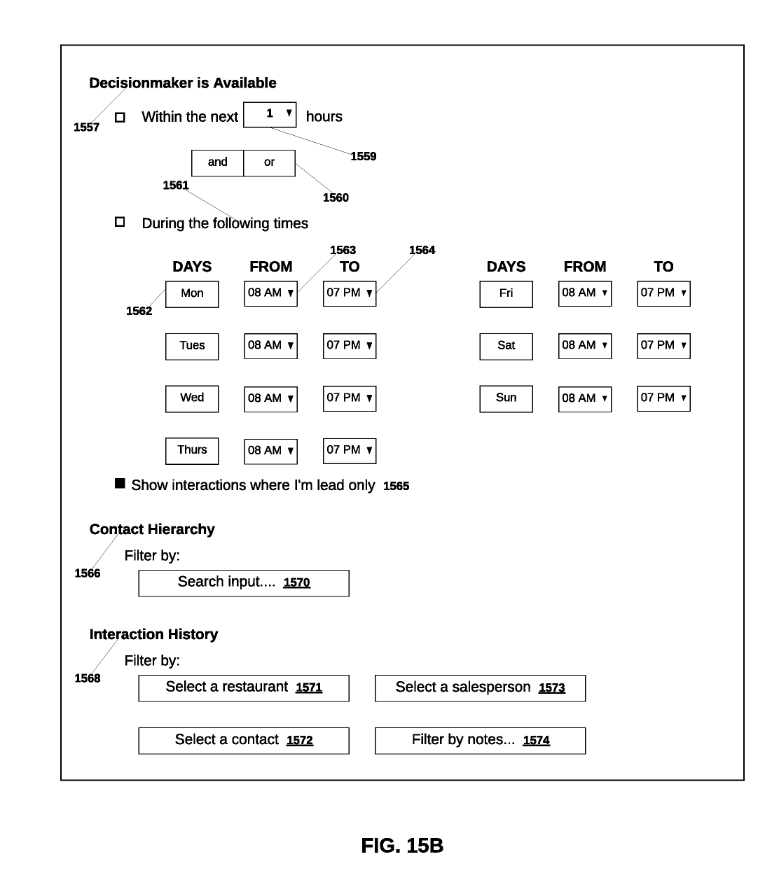

Referring to FIGS. 15A and 15B, an exemplary customer relations management decisionmaker settings screen 1500 according to an embodiment is illustrated. In certain embodiments, the system may allow certain users (e.g., third-party vendors, sales personnel, etc.) to efficiently search for, connect with, and create partnerships with target personnel of vendors. It will be appreciated that a broad range of such users may utilize the customer relations management decisionmaker settings and are collectively referred to herein as “third-party vendors” for convenience. Moreover, a broad range of target personnel of vendors exist (collectively referred to herein as “decisionmakers” for convenience). In an exemplary embodiment where the user is a third-party vendor and the target personnel is a decisionmaker, the system may allow such third-party vendor to search by and view the decisionmaker's information and availability.

Referring to FIG. 15A, a third-party vendor may perform a targeted search for a decisionmaker through the use of any number of filters 1502, including by zip code in the third-party vendor's territory 1504, distance from current location 1550 by radius specified by the third-party vendor 1554 (e.g., via a scale), performance metrics (e.g., percentage close below 1510 or above 1514 an amount specified by the third-party vendor, revenue per month either below 1518 or above 1522 an amount specified by the third-party vendor), a minimum number of locations owned by the vendor 1526, and date (e.g., availability of the vendor before 1542 or after 1530 a date and/or time specified by the third-party vendor). In the embodiment shown, the third-party vendor may provide information to the system by means of one or more textual forms, positioning a slider along a scale, and/or by means of drop-down menus. In one embodiment, the screen 1500 may allow the third-party vendor to select the order in which results are shown 1544. For example, this screen may allow the third-party vendor to select from multiple sorting options, including newest unrecorded follow-up by the third-party vendor 1545 (e.g., decisionmakers for whom a follow-up meeting with the third-party vendor has not yet been scheduled).

Referring to FIG. 15B, the third-party vendor may further filter search results for a decisionmaker by specifying the time(s) at which the decisionmaker is available within the “Decisionmaker is Available” 1557 section. In the illustrated embodiment, the third-party vendor may elect to search for a decisionmaker available within a certain number of hours specified by the third-party vendor 1559, and/or 1560 search for a decisionmaker within a range of times 1561. For example, in the embodiment shown, the third-party vendor may search for a decisionmaker available on a specific day (e.g., “Monday” 1562) from a specific start time (e.g., “8 AM” 1563), to a specific end time (e.g., “7 PM” 1564). The third-party vendor may also elect to show only available meeting times/interactions where the third-party vendor is the primary party interacting with the decisionmaker 1565. The third-party vendor may additionally search for and filter interactions 1570 with decisionmakers that meet a minimum threshold within a contact hierarchy 1566. Although not shown, it will be appreciated that the third-party vendor may utilize additional filters for the decisionmakers, including but not limited to: number of previous interactions; amount purchased from the third-party vendor; minimum profit amount; minimum number of reviews; minimum rating; etc.

The third-party vendor may additionally search for decisionmakers based on interaction history 1568 (e.g., interactions that the third-party vendor has previously had with vendors). The third-party vendor may filter within such interaction history 1568 by previous restaurant(s) 1571, contact(s) 1572, salesperson(s) 1573, and/or notes 1574. The third-party vendor may then create an interaction or appointment with the decisionmaker.

Various embodiments are described in this specification, with reference to the details discussed above, the accompanying drawings, and the claims. Numerous specific details are described to provide a thorough understanding of various embodiments. However, in certain instances, well-known or conventional details are not described in order to provide a concise discussion. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the embodiments.

The embodiments described and claimed herein and drawings are illustrative and are not to be construed as limiting the embodiments. The subject matter of this specification is not to be limited in scope by the specific examples, as these examples are intended as illustrations of several aspects of the embodiments. Any equivalent examples are intended to be within the scope of the specification. Indeed, various modifications of the disclosed embodiments in addition to those shown and described herein will become apparent to those skilled in the art, and such modifications are also intended to fall within the scope of the appended claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

One or more aspects of embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the invention should not be construed as limited to any one set of computer program instructions. Further, a skilled programmer would be able to write such a computer program to implement an embodiment of the disclosed invention based on the appended flow charts and associated description in the application text. Therefore, disclosure of a particular set of program code instructions is not considered necessary for an adequate understanding of how to make and use the invention. Further, those skilled in the art will appreciate that one or more aspects of the embodiments described herein may be performed by hardware, software, or a combination thereof, as may be embodied in one or more computing systems. Moreover, any reference to an act being performed by a computer should not be construed as being performed by a single computer as more than one computer may perform the act.

All references including patents, patent applications and publications cited herein are incorporated herein by reference in their entirety and for all purposes to the same extent as if each individual publication or patent or patent application was specifically and individually indicated to be incorporated by reference in its entirety for all purposes.

What is claimed is:

1. A computer-implemented method comprising:
receiving a product review from a user, the product review comprising:
user information associated with the user;
a product associated with product information; and
a first vendor associated with first vendor information;
receiving, from a requestor, a request to determine a product recommendation for a second vendor associated with second vendor information;
determining the product recommendation, based on the second vendor information and one or more of the user information, the product information and the first vendor information; and
transmitting the product recommendation to the requestor.

2. A computer-implemented method according to claim 1 further comprising receiving an order associated with the product,
wherein said determining the product recommendation is further based on the order.

3. A computer-implemented method according to claim 1, wherein:
the first vendor information comprises a first location;
the second vendor information comprises a second location; and
said determining the product recommendation is based on the first location being within a predetermined distance from the second location.

4. A computer-implemented method according to claim 3, further comprising:
receiving a second product review from a second user, the second product review comprising:
second user information associated with the second user;
a second product associated with second product information; and
a third vendor associated with third vendor information comprising a third location,
wherein the third location is not located within a predetermined distance from the second location; and
wherein said determining the product recommendation is not based on the second product information.

5. A computer-implemented method according to claim 1, wherein the product recommendation comprises some or all of the product information.

6. A computer-implemented method according to claim 5, wherein:
the second vendor information comprises a plurality of products; and
the plurality of products does not include the product.

7. A computer-implemented method according to claim 1, wherein:
the product information comprises a product type and a product component;
the second vendor is associated with a second product that is itself associated with second product information comprising the product type, but not the product component; and
the product recommendation comprises a recommendation to include the product component in the second product.

8. A computer-implemented method according to claim 1, wherein:
the product is a food item; and
the product recommendation comprises some or all of the product information associated with the food item.

9. A computer-implemented method according to claim 8 further comprising receiving an order associated with the food item,
wherein said determining the product recommendation is further based on the order.

10. A computer-implemented method according to claim 8, wherein the product recommendation comprises a food ingredient associated with the food item.

11. A computer-implemented method according to claim 10, wherein:
the product information comprises a food type and a food ingredient;
the second vendor is associated with a second food item that is itself associated with second product information comprising the food type, but not the food ingredient; and
the product recommendation comprises a recommendation to include the food ingredient in the second food item.

12. A computer-implemented method comprising:
displaying a plurality of products for sale;
receiving a product order from a user, the product order comprising a product selected from the plurality of products and associated with a vendor;
transmitting a notification to the user to review the product;
receiving, from the user, a review associated with the product, the review comprising one or more of a rating, a comment and an answer to a question;
determining a reward, based on one or more of the group consisting of: the user, the product, the vendor and the review; and
providing the reward to the user.

13. A computer-implemented method according to claim 12, wherein said determining the reward is further based on one or more of the group consisting of:
the review is a first review received from the user;
the review is a first review associated with the vendor received from the user;
the review is a first review associated with the vendor received from any user;
the review is associated with review information matches a predetermined review criterion;
the product is a first product ordered by the user;
the product is a first product associated with the vendor ordered by the user;
the product is a first product associated with the vendor ordered by any user; and
the product is associated with product information that matches a predetermined product criterion.

14. A computer-implemented method according to claim 12, wherein the determining the reward is further based on one or more the group consisting of:
a total number of reviews received from the user is greater than or equal to a predetermined review milestone; and
a total number of products ordered by the user is greater than or equal to a predetermined order milestone.

15. A computer-implemented method according to claim 12, wherein:
the product comprises a reservation for a user-defined length of time; and
said determining the reward is further based on the user-defined length of time being less than or equal to a predetermined maximum amount of time.

16. A computer-implemented method according to claim 12, wherein:
the review comprises the answer to a question;
the question relates to a subjective value of the product; and
said determining the reward is further based on the answer to the question.

17. A computer-implemented method according to claim 16, wherein said determining the reward is further based on one or more of the group consisting of:
the answer is a first answer received from the user;
the answer is a first answer to the question received from the user;
the answer is a first answer to the question received from any user;
the answer comprises a determined quality that meets a predetermined quality criterion; and
the answer comprises a number of characters that is greater than or equal to a predetermined minimum number of characters.

18. A computer-implemented method according to claim 12, further comprising transmitting a second notification to the user.

19. A computer-implemented method according to claim 18, wherein:
the second notification instructs the user to use the reward; and
said transmitting the second notification is based on one or more of the group consisting of:
the user is located within a predetermined distance from the vendor; and
the reward will expire within a predetermined amount of time.

20. A computer-implemented method according to claim 18, wherein:
the second notification includes information relating to a user location of the user; and
said transmitting the second notification is based on one or more of the group consisting of:
the user location is within a predetermined distance from a location of the product;
the user location is within a predetermined distance from a destination location;
the user location is within a predetermined distance from a location of a second user;
the user location is within a predetermined distance from a location of a second vendor.

21. A computer-implemented method according to claim 12, further comprising:
receiving a second product order from the user, the second product order comprising a second product selected from the plurality of products and associated with the vendor;
determining a second reward, based on the second product order; and
providing the second reward to the user.

22. A computer-implemented method according to claim 21, wherein the second reward is a loyalty reward.

23. A computer-implemented method according to claim 21, further comprising receiving, from the user, a second review associated with the second product,
wherein said determining the second reward is further based on the second review.

24. A computer-implemented method according to claim 23, wherein the second reward is a repeat reviewer reward.
